(19) United States
(12) Patent Application Publication
(10) Pub. No.: US 2006/0169948 A1
(43) Pub. Date: Aug. 3, 2006

(54) Liquid hardness agent for open cell foams

(76) Inventors: Paul L. Neill, Grayslake, IL (US); Ronald M. Herrington, Brazoria, TX (US); James E. Stogis, Joliet, IL (US); Rick L. Tabor, Glenview, IL (US); Warren A. Kaplan, Grayslake, IL (US); Douglas Kip Hillshafer, Western Springs, IL (US); James D. Hoesly, Buffalo Grove, IL (US)

Correspondence Address: MCANDREWS HELD & MALLOY, LTD, 500 WEST MADISON STREET, SUITE 3400, CHICAGO, IL, 60661, US

(21) Appl. No.: 11/390,505

(22) Filed: Mar. 27, 2006

Related U.S. Application Data
(63) Continuation of application No. 10/831,653, filed on Apr. 23, 2004.
(60) Provisional application No. 60/464,969, filed on Apr. 23, 2003.

(51) Int. Cl. C08G 18/00; C09K 3/00

(52) U.S. Cl. 252/182.24; 521/170; 521/172

(57) ABSTRACT

The present invention provides a ring-containing component polyol and process for making the same for use as a load-bearing capacity improvement agent in flexible polyurethane foam manufacture. The ring-containing component polyol eliminates and/or reduces the need for a copolymer polyol containing suspended solids in the manufacture of flexible foam products. This may reduce production costs, reactivity variations, filter plugging, color variations, foam shrinkage/tightness, foam irregularity, and foam malodor while maintaining an adequate load-bearing capacity. The present polyol blends can be non-opaque or transparent.

### CROSS-REFERENCE TO RELATED APPLICATIONS

The benefit of U.S. Provisional Application No. 60/464,969, filed Apr. 23, 2003, is claimed. The provisional application is incorporated here by reference to provide continuity of disclosure.

The benefit of U.S. application Ser. No. 10/831,653, filed Apr. 23, 2004, is claimed. The utility application is incorporated here by reference to provide continuity of disclosure.

### STATEMENT REGARDING FEDERALLY SPONSORED RESEARCH OR DEVELOPMENT

NONE

### BACKGROUND OF THE INVENTION

The present invention relates to open cell polyurethane foams made from polyisocyanates and polyols. In particular, the present invention provides a polyol or polyol blend foam intermediate composition, a foam composition, flexible material and articles made from the foam, and methods of making the same that contain at least one ring-containing component polyol capable of aiding in the control of the load-bearing capacity of flexible polyurethane foams.

### PRIOR ART FOAM FORMULATION

Flexible polyurethane foams are chemically and physically complex synthetic materials formed by the reaction of polyisocyanate compounds with polyol resin compounds in the presence of a number of other formulation ingredients. Flexible polyurethane foams are typically produced using either slabstock foam manufacturing processes or molded flexible foam manufacturing processes. An example of a prior art formulation which may be utilized for flexible foam manufacturing processes is set forth below:

TABLE 1

| Component | Parts |
|---|---|
| HYPERLITE E-848 Polyol | 70 |
| HYPERLITE E-849 Copolymer Polyol | 30 |
| NIAX Y-10184, Surfactant | 1.2 |
| Diethanol Amine, pure | 1.4 |
| DABCO 33-LV, amine catalyst | 0.35 |
| NIAX A-1, amine catalyst | 0.08 |
| Water | 4.2 |
| Toluene Diisocyanate Index | 80-120 |

In this particular prior art formulation, HYPERLITE E-848 Polyol serves as a base polyol component and HYPERLITE E-849 is a copolymer polyol component, each commercially available from Bayer Corporation of Leverkusen, Germany. The base polyol is typically the major component of a foam formulation and is generally chosen with regard to the bulk properties desired in the final foam. The copolymer polyol is a dispersion of microscopic, discontinuous, solid polymer particles in a continuous polyol matrix. The copolymer polyol functions as a load-bearing adjusting additive.

Surfactants such as NIAX Y-10184 aid in reducing the surface and interfacial tensions between various components of the foam producing formulations. NIAX Y-10184 is a silicone-based surfactant commercially available from GE-Silicones.

Diethanol amine functions as a stabilizing crosslinker, and DABCO 33-LV and NLAX A-1 are amine catalysts that aid in the polymerization and curing of the foam intermediate composition into a resultant foam product. DABCO 33-LV is a 33 weight % solution of triethylene diamine in dipropylene glycol and is commercially available from Air Products and Chemicals, Incorporated, Allentown, Pa. NIAX A-1 is a 70 weight % solution of bis(dimethylaminoethyl) ether in dipropylene glycol and is commercially available from Crompton OSI Specialties, Incorporated, Middlebury, Conn.

Toluene diisocyanate (TDI) is used to react with the active hydrogen ingredients in the listing to produce a high molecular weight polymer. TDI also reacts with the water to generate carbon dioxide which is used to blow the reaction mixture to form the cells of the foam.

Flexible Slabstock Foam

Commercial scale production of flexible slabstock foams began in North America in about 1954 and was based on the use of aliphatic polyester-type polyols (often made into prepolymers prior to the foaming event). These early foams proved unable to withstand many in-use temperature and humidity conditions and often failed by decomposition under these conditions. Improved performance was obtained with the introduction of high-purity polyether-type polyols in about 1957. Foams based on these polyols were less affected by hydrolysis and thus more durable.

A slabstock/one-shot type foam is typically produced in either a high pressure or low pressure machine having a continuous mixer. Such continuous mixing machines may, generally, produce 100 pounds or more per minute of slabstock foam.

In general, the production of slabstock foam involves the metering of foam ingredients from separate feed lines (i.e., streams) via a mixing head having a pin mixer or high shear mixer. Typically, slabstock foam is made from a polyether polyol; a polyisocyanate such as toluene diisocyanate; an amine catalyst and a tin catalyst. The polyether polyol often comprises mostly secondary OH groups.

Further information regarding the production of slabstock foam can be found in the following prior art references: Frisch, K. C. and Saunders, J. H., Polyurethanes: Chemistry and Technology Part II, High Polymers, vol. XVI, part II, pp. 85-191 (1983); Sandridge, R. L., et al., Effect of Catalyst Concentrations on One-shot Polyether Flexible Urethane Foams, American Chemical Society, Division of Organic Coating Plastics Chemistry, Preprints (1961), 21 (no. 2), pp. 68-78; and U.S. Pat. Nos. 3,194,773 and 3,546,145. Such references are illustrative of prior art slabstock foam processing, but are not intended to be an exhaustive list.

Molded Flexible Foams

The primary characteristic of a foam cushion that is adjusted to meet a particular functional requirement is the load-bearing capacity. The load-bearing capacity of flexible polyurethane foam is its ability to receive and support a given weight at a particular deflection.

Load-bearing capacity in flexible foams, and methods to enhance it, are subjects that have been continuously studied since the foam cushioning industry began (with the installation of natural rubber latex foam seat cushions in London buses in 1932). Methods to improve load-bearing in flexible polyurethane foams have been studied since their commercial introduction in 1954. The following is a list of some of the major known contributing factors to the load-bearing capacity of a flexible polyurethane foam: density, water level, cell size, cell openness, packing, fillers, use of expandable beads, copolymer polyol levels, polyisocyanate type and index, use of cross-linkers, polyol functionality, use of chain extenders, polymer morphology adjustments, and use of specific catalysts.

Of these known methods to adjust the load-bearing capacity of flexible polyurethane foam, the most commonly used method is the inclusion of copolymer polyols in the reacting foam mixture. As mentioned above, copolymer polyols are dispersions of microscopic, discontinuous, solid polymer particles in a continuous polyol matrix. The first commercial copolymer polyols appeared in 1966 and were based on the use of acrylonitrile as the sole monomer. These products were instrumental in the commercial acceptance of molded high-resiliency (HR) foams for use in automobile seating. By the early 1970's, copolymer polyols had become the preferred method for increasing foam load-bearing capacity in polyurethane foams. A wide range of foam hardness could be obtained simply by using more or less of the product. The solid particles behaved as a classical filler, but were available in an easy to use liquid form. Over the years, deficiencies in the 100% acrylonitrile products led to the development of styrene-acrylonitrile (SAN) copolymer polyols. The following patents are some examples of the many patents and patent applications in this area: U.S. Pat. Nos. 3,304,273; 3,523,093; 3,931,092; 3,953,393; 4,104,236; 4,186,271; 4,242,476; 4,390,645; 4,454,255; 4,495,341; 4,521,546; 4,539,339; 4,539,378; 4,745,153; 4,931,483; 5,171,759; 5,741,847; 6,455,185; Re. 28,715; Re. 29,118; GB 2070628; GB 2179356; GB 2309700; WO 94/20558; WO 97/15606; WO 99/40144; WO 00/00531; and WO 01/09242. The entire contents of these patents and patent applications are incorporated here by reference.

Although commercially successful, the SAN type copolymer polyols are not without deficiencies.

Manufacturers of copolymer polyols normally ship product at plus or minus 2 weight percent of the target percent solids specification. This means, for example, that shipments of a nominal 40% solids copolymer polyol could arrive containing anywhere from 38 to 42% solids.

Variations in the weight percent solids in the delivered copolymer polyol product and variations in the average particle size contribute to variations in the load-bearing capacity observed in the final produced foam. Foam manufacturers normally have multiple foam recipes that they use daily in each of their production plants to make a wide variety of foams as desired. These recipes are designed around the copolymer polyol product having some nominal weight percent solids level and are not typically adjusted for the actual solids level of each incoming lot of product. Thus, variation in the actual weight percent of solids and the resultant load-bearing capacity is inherent in the current start and stop, semi-continuous processes used to make molded flexible foam.

Further, as the actual level of solids varies in the copolymer polyol product so will the viscosity of the neat copolymer polyol. Variations in the concentration of particle stabilizer also contribute to viscosity variations in the neat copolymer polyol. It is not uncommon for viscosities of individual shipments of copolymer polyol to vary plus or minus 1000 mPa∘s at 25° C. around the product's target specification.

Moreover, when the copolymer polyol is formulated into a masterbatch with the other ingredients, the viscosity of that masterbatch increases in direct relationship to the amount of copolymer polyol used. In some cases, the resultant masterbatch viscosity can be so high as to challenge the pumping and metering capabilities of the foam making equipment.

A common industrial problem with using copolymer polyols is the plugging of filters located at several key points in a foam production process. The filters may be used to catch solid contaminants arising from normal shipping and handling operations so that process upsets and down time do not affect plant operations. Even though copolymer polyols are typically specified as having average particle sizes in the range of 1 micron or smaller, it is common for any given shipment of product to plug 100 micron and even larger sized filters.

Further, variations in the reactivity of prior art copolymer polyols arise from normal lot-to-lot variability in the polyol which is used to carry the suspended styrene/acrylonitrile particles.

Prior art copolymer polyols present additional problems in that the color of a neat copolymer polyol product can vary and this in turn can vary the color of the foam produced. Color variations arise from intended or unintended changes in the ratio of styrene to acrylonitrile monomers. The usual color of a copolymer polyol product is white, but the color of the resulting foam may have a yellowish hue as the ratio of acrylonitrile to styrene is increased. Further problems may result from the overheating of a copolymer polyol at the foam manufacturing plant during off-loading of the copolymer polyol in the winter, resulting in a more yellow colored product and final foam.

Still further, the odor of the copolymer polyol often transfers into the foam production plant and into the foams produced therein. This presents important quality issues. In the copolymer polyol product, odors can arise from the presence of residual styrene or acrylonitrile monomers as well as from the myriad of free radical fragments formed during polymerization.

A number of proffered alternative types of copolymer polyols have been studied and reported—e.g., polyurea copolymer polyols (see U.S. Pat. Nos. 3,325,421; 4,089,835; 4,093,569; 4,107,102; 4,296,213; 4,523,025; and 4,761,434); polyisocyanate polyaddition copolymer polyols (see U.S. Pat. Nos. 3,360,495; 4,260,530; 4,374,209; 4,438,252; 4,452,923; 4,497,913; 4,525,488; 4,554,306; 4,595,709; 4,785,026; 5,068,280; 5,179,131; and 5,292,778 and GB 2 102 824 A); epoxy dispersion copolymer polyols (see U.S. Pat. Nos. 4,305,861; 4,789,690; and 5,244,932); and miscellaneous other copolymer polyols (see U.S. Pat. Nos. 4,323,657; 4,326,043; 4,435,527; 4,435,537; 4,452,922; 4,521,581; 5,594,072; WO 01/88005; and WO 02/10247).

Other alternative approaches include those reported in U.S. Pat. Nos. 3,454,530; 3,957,753; 4,237,240; 4,374,935; 4,469,823; 4,524,157; 4,568,717; 5,003,027; and 5,606,005.

Notwithstanding its shortcomings, however, until now the use of SAN type copolymer polyols has been the commercially preferred approach for increasing the load-bearing capacity of flexible polyurethane foam.

### BRIEF SUMMARY OF THE INVENTION

It has been discovered that the present invention overcomes shortcomings of prior art foam formulations containing copolymer polyols, either in whole or in part, while achieving adequate load-bearing capacities for various foam products.

It is therefore an object of the present invention to provide polyurethane foam that eliminates or reduces one or more of the shortcomings of the prior art.

It is a further object of the present invention to provide a ring-containing component polyol or ring-containing component polyol blend that has reduced levels of suspended solids, such as the SAN particles typically found in some prior art copolymer polyols.

Another object of the invention is to replace the copolymer polyol in part or entirely with another load-bearing additive.

It is yet a further object of the invention to provide an open cell polyurethane foam derived from a ring-containing component polyol or ring-containing component polyol blend that reduces or eliminates at least some of the shortcomings associated with copolymer polyols including, but not limited to variations in weight percent solids and average particle size; variations in viscosity of the neat product and increased viscosity of the foam formulation masterbatch (due to the inherent high viscosity of copolymer polyols); filter plugging; reactivity variations; color variations; foam shrinkage/tightness; foam irregularity; and/or foam malodor.

The present invention is intended to satisfy one or more of the foregoing objects at least in part.

Several terms used below are specifically defined as follows.

All parts and percentages herein are by weight unless otherwise indicated or apparent.

A “ring,” as used in the term “ring-containing component polyol” or otherwise, is broadly defined here to include aromatic monocyclic or polycyclic rings, aliphatic monocyclic or polycyclic rings, and includes carbocyclic or heterocyclic rings of any of these types. The ring-containing component polyol optionally can have a hydroxyl functionality between 1.7 and 3.5.

An “aromatic polyol” is broadly defined here to include aromatic monocyclic or polycyclic rings, and includes carbocyclic or heterocyclic rings of either of these types. The aromatic polyol optionally can have a hydroxyl functionality between 1.7 and 3.5.

Any reference to a material having a certain characteristic refers either to a single material or a mixture or blend of materials having, in aggregate, that characteristic, unless the context clearly indicates otherwise. For example, unless the context indicates otherwise, a “polyol” refers to a polyol or a polyol blend.

One aspect of the invention is a polyol blend suitable for use in preparing a flexible foam. The blend includes 50% to 99% of a base polyol and 1% to 50% of a second polyol that is a ring-containing component polyol, the second polyol having more than 50% of its hydroxyl groups as secondary hydroxyl groups.

Another aspect of the invention is a polyol blend including 50 to 99% of a base polyol and 1% to 50% of a second polyol that is a non-halogenated aromatic polyester polyol having a hydroxyl functionality between 1.7 and 3.5, the second polyol being the reaction product of an aromatic dibasic acid, aromatic anhydride, aromatic diester or mixture thereof with a glycol, the aromatic dibasic acid, aromatic anhydride, aromatic diester or mixture thereof including less than 20 mole percent aliphatic dibasic acid, aliphatic anhydride or aliphatic diester.

Yet another aspect of the invention is a polyol blend including 50 to 99% of a base polyol and I% to 50% of at least one second polyol that is a non-halogenated ring-containing component polyol having a hydroxyl functionality between 1.7 and 3.5, the second polyol being the reaction product of a ring-containing component aliphatic dibasic acid, ring-containing component aliphatic anhydride, ring-containing component aliphatic diester or mixture thereof with a glycol, the ring-containing component aliphatic dibasic acid, anhydride, ester or mixture thereof including less than 20 mole percent linear aliphatic dibasic acid.

Still another aspect of the invention is a polyol blend including 50 to 99% of a base polyol and 1% to 50% of a second polyol that is a non-halogenated ring-containing component polyol having a hydroxyl functionality between 1.7 and 3.5, the second polyol including a non-polyester polyol.

Even another aspect of the invention is a polyol blend including 50 to 99% of a base polyol and 1% to 50% of a second polyol that is a halogen-containing, ring-containing component polyol or a halogen-containing, ring-containing component polyol blend having a hydroxyl functionality between 1.7 and 3.5, the second polyol being substantially free of any inorganic particulate solids.

An additional aspect of the invention is a polyol blend including 50 to 99% of a base polyol and a second polyol that is an aromatic polyol, the polyol blend being substantially free of inorganic fire retardant particulates, the second polyol having less than about 20 mole % linear aliphatic dibasic acid.

Still another aspect of the invention is a polyol blend including 50 to 99% of a base polyol and a second polyol that is a ring-containing component polyol, the polyol blend being substantially free of inorganic fire retardant particulates, the second polyol having less than about 20 mole % linear aliphatic dibasic acid, the second polyol further including a copolymer polyol having a solids content of greater than 30 weight percent.

Another aspect of the invention is a polyol blend including 50 to 99% of a base polyol and 1% to 50% of a second, ring-containing component polyol, the polyol blend being substantially free of inorganic fire retardant particulates, the second polyol having less than about 20 mole % linear aliphatic dibasic acid, the polyol blend being substantially free of load-bearing-enhancing solids.

An additional aspect of the invention is a polyol blend including 50 to 99% of a base polyol and 1% to 50% of a second polyol that is a ring-containing component polyol or a ring-containing component polyol blend having a hydroxyl functionality between 1.7 and 3.5. The polyol blend of this embodiment is substantially free of inorganic fire retardant particulates, the ring-containing component polyol or ring-containing component polyol blend has less than about 20 mole % linear aliphatic dibasic acid, and the ring-containing component polyol further includes from 0.5% to 30% by weight of a dendritic macromolecule.

One optional feature of each aspect of the invention is that the polyol blend can be substantially free of aromatic diamines.

In any aspect of the invention the viscosity of the polyol blend optionally is from 1000 to 10,000 mPa∘s when measured at 25° C. using a Brookfield viscometer.

As another optional feature of any embodiment of the invention, the polyol blend can be non-opaque to 450 nm wavelength light, or can have a transmittance to 450 nm wavelength light of at least 5%, optionally at least 10%, optionally at least 25%, optionally at least 50%, optionally at least 80%, optionally at least 85%, optionally at least 90%, optionally at least 95%, using a 1-centimeter path length quartz cuvette. Optionally, the polyol blend of any embodiment can be transparent. The polyol blend of any embodiment reciting such a composition optionally has a Gardner color index not exceeding 5.

Even another aspect of the invention is a polyol blend including 61 to 99 parts by weight per 100 parts polyols of at least one base polyol, and 1 to 39 parts by weight per 100 parts polyols of a second polyol that is a load-bearing polyol consisting essentially of an aromatic/polyester polyol, the polyol blend being reactable with a polyisocyanate under foam forming conditions to produce a foam.

Still another aspect of the invention is a polyol blend including a base polyol and a second, ring-containing component polyol including the reaction product of an essentially ring-containing component dibasic acid, anhydride, diester or mixture thereof with a glycol, the ring-containing component dibasic acid, aromatic anhydride, aromatic diester or mixture thereof including less than 20 mole percent of a non-ring-containing component dibasic acid, a non-ring containing anhydride, a non-ring-containing component diester, or combinations thereof, having more than 50% of its hydroxyl groups as secondary hydroxyl groups, and being substantially free of load-bearing enhancing solids.

Yet another aspect of the invention is a polyol blend including 61 to 99 parts by weight per 100 parts polyols of at least one base polyol and 1 to 39 parts by weight per 100 parts polyols of a second polyol that is a ring-containing component load-bearing polyol; the polyol blend being reacted with a polyisocyanate under foam-forming conditions, in the presence of a blowing agent.

An additional aspect of the invention is a polyol blend including a base polyol and 1 to 50 parts by weight per 100 parts polyols of a second polyol that is a ring-containing component load-bearing polyol, the viscosity of the polyol blend not exceeding about 10,000 mPa∘s when measured at 25° C. using a Brookfield viscometer.

Still another aspect of the invention is a flexible foam made by reacting the polyol blend of any aspect of the invention with a polyisocyanate composition under foam-forming conditions.

An additional aspect of the invention is a flexible foam having a density of 16 to 144 kg/m³, optionally 26 to 45 kg/m³, made by reacting the polyol blend of any aspect of the invention with a polyisocyanate in the presence of a blowing agent.

The flexible foam of any aspect of the invention optionally includes an amount of the ring-containing component polyol effective to increase the 65% indentation force deflection (IFD) of the foam.

In the foam of any aspect of the invention the base polyol optionally includes less than 10 weight percent of a ring-containing component dibasic acid, ring-containing component anhydride or ring-containing component diester.

Even another aspect of the invention is a flexible foam made by reacting ingredients including the polyol blend of any aspect of the invention and a polyisocyanate, in the presence of a blowing agent.

Another aspect of the invention is a flexible foam made by reacting ingredients including a base polyol, 1 to 50 parts by weight per 100 parts polyols of a second polyol that is a load-bearing polyol, and a polyisocyanate, in the presence of a blowing agent, the foam having a load-bearing efficiency at 65% indentation force deflection of from 2 to 25 Newtons per part by weight of the load-bearing polyol and the viscosity of the base polyol combined with the load-bearing polyol not exceeding about 10,000 mPa∘s when measured at 25° C. using a Brookfield viscometer.

Still another aspect of the invention is a flexible foam made by reacting ingredients including a base polyol having an average functionality of less than 5.5, 1 to 50 parts by weight per 100 parts polyols of a second polyol that is a ring-containing component load-bearing polyol, and a polyisocyanate, in the presence of a blowing agent.

Additionally, one aspect of the invention is a flexible foam made by reacting ingredients including a non-opaque polyol blend of a base polyol and 1 to 50 parts by weight per 100 parts polyols of a second polyol that is a ring-containing component load-bearing polyol, and a polyisocyanate, in the presence of a blowing agent.

An aspect of the invention is a flexible foam made by reacting ingredients including a non-opaque polyol blend of a base polyol and 1 to 50 parts by weight per 100 parts polyols of a second polyol that is a ring-containing component load-bearing polyol and a polyisocyanate, in the presence of a blowing agent.

Still another aspect of the invention is a flexible foam made by reacting ingredients including a non-opaque polyol blend of a base polyol and 1 to 50 parts by weight per 100 parts polyols of a second polyol that is a ring-containing component load-bearing polyol, and a polyisocyanate, in the presence of a blowing agent.

Another aspect of the invention is a flexible foam made by reacting ingredients including a ring-containing component load-bearing polyol having less than 10 percent by weight particulate material and a polyisocyanate, in the presence of a blowing agent.

Still another aspect of the invention is a flexible foam made by reacting ingredients including a base polyol, 1 to 50 parts by weight per 100 parts polyols of a second polyol that is a ring-containing component load-bearing polyol, and a polyisocyanate, in the presence of a blowing agent.

Still another aspect of the invention is a flexible foam made by reacting ingredients including a base polyol, 1 to 50 parts by weight per 100 parts polyols of a second polyol that is a ring-containing component load-bearing polyol, and a polyisocyanate, in the presence of a blowing agent, the foam having a density of from 6 to 240 kg/m³ and requiring a 65% indentation deflection of from 9 to 15 Newtons per 323 square cm. per kg/m³.

Yet another aspect of the invention is a flexible polyurethane foam made from the polyol blend of any aspect of the invention.

Another optional feature of the foam of any aspect of the invention is a 65% indentation force deflection guide factor of from 5 Newtons to 20 Newtons, optionally from 7.5 to 20 Newtons, optionally from 4 to 19 Newtons, optionally 7 to 15 Newtons optionally from 7 to 18 Newtons, optionally from 9 to 15 Newtons, optionally from 9 to 18 Newtons, optionally from 11.5 to 20 Newtons, or any other combination of these lower and upper limits, per 323 sq. cm. per kg/m³. The “indentation force deflection guide factor” is defined as the ratio of an indentation value, such as the 65% or 25% IFD, to the density of the foam. This term is useful in determining the relative firmness of foams having different densities.

Still another optional feature of the foam of any aspect of the invention is a load-bearing efficiency at 65% indentation force deflection of from 0.8 to 20 Newtons, alternately from 2 to 25 Newtons, optionally from 2.3 to 24 Newtons, optionally from 2.5 to 23 Newtons, optionally from 2.8 to 22 Newtons, optionally from 13 to 25 Newtons, or any other combination of these lower and upper limits, per 323 sq. cm. per part by weight of the second polyol.

The foam of any aspect of the invention optionally has a density of from 6 to 240 kg/m³, optionally from 8 to 160 kg/m³, optionally from 24 to 64 kg/m³.

Yet an additional aspect of the invention is a flexible foam pad having a density of 16 to 144 kg/m³ made by reacting the polyol blend of any aspect of the invention with a polyisocyanate in the presence of a blowing agent to form a foam intermediate composition, and fabricating a foam pad from the foam intermediate composition. Optionally, the pad can have a density of 26 to 45 kg/m³. Optionally, the pad can include an amount of the ring-containing component polyol effective to increase the 65% IFD of the foam. Optionally, the base polyol can include less than 10 weight percent ring-containing component dibasic acid, ring-containing component anhydride or ring-containing component diester.

Even another aspect of the invention is a flexible foam pad made by reacting ingredients including the polyol blend of any aspect of the invention and a polyisocyanate, in the presence of a blowing agent, to form a foam intermediate composition, and fabricating a foam pad from the foam intermediate composition, the foam having a load-bearing efficiency at 65% indentation force deflection of from 2 to 25 Newtons, optionally from 2.5 to 24 Newtons, optionally from 2.75 to 23 Newtons, optionally from 3 to 22 Newtons, per part by weight of the load-bearing polyol.

An additional aspect of the invention is a flexible foam pad made by reacting ingredients including a base polyol, 1 to 50 parts by weight per 100 parts polyols of a second polyol that is a load-bearing polyol, and a polyisocyanate, in the presence of a blowing agent, to form a foam intermediate composition, and fabricating a foam pad from the foam intermediate composition, the foam having a load-bearing efficiency at 65% indentation force deflection of from 2 to 25 Newtons per part by weight of the load-bearing polyol and the viscosity of the base polyol combined with the load-bearing polyol not exceeding about 10,000 mPa∘s when measured at 25° C. using a Brookfield viscometer.

Another aspect of the invention is a flexible foam pad made by reacting ingredients including a base polyol having an average functionality of less than 5.5, 1 to 50 parts by weight per 100 parts polyols of a second polyol that is a ring-containing component load-bearing polyol, and a polyisocyanate, in the presence of a blowing agent, to form a foam intermediate composition, and fabricating a foam pad from the foam intermediate composition. The foam has a load-bearing efficiency at 65% indentation force deflection of from 2 to 25 Newtons per part by weight of the load-bearing polyol.

Even another aspect of the invention is a flexible foam pad made by reacting ingredients including a non-opaque polyol blend of a base polyol and 1 to 50 parts by weight per 100 parts polyols of a second polyol that is a ring-containing component load-bearing polyol with a polyisocyanate, in the presence of a blowing agent, to form a foam intermediate composition. A foam pad is fabricated from the foam intermediate composition. The foam has a load-bearing efficiency at 65% indentation force deflection of from 0.8 to 25 Newtons per part by weight of the load-bearing polyol.

Even another aspect of the invention is a flexible foam pad made by reacting ingredients including a non-opaque polyol blend of a base polyol and 1 to 50 parts by weight per 100 parts polyols of a second polyol that is a ring-containing component load-bearing polyol, and a polyisocyanate, in the presence of a blowing agent, to form a foam intermediate composition. A foam pad is fabricated from the foam intermediate composition, the foam having a 65% indentation force deflection guide factor of from 5 to 20 Newtons, optionally from 6 to 19 Newtons, per 323 sq. cm. per kg/m³.

Still another aspect of the invention is a flexible foam pad made by reacting ingredients including a ring-containing component load-bearing polyol having less than 10 percent by weight particulate material and a polyisocyanate, in the presence of a blowing agent, to form a foam intermediate composition and fabricating a foam pad from the foam intermediate composition. The foam can have a 65% indentation force deflection guide factor of from 5 to 20 Newtons, optionally from 6 to 19 Newtons, per 323 square cm. per kg/m³.

Another aspect of the invention is a flexible foam pad made by reacting ingredients including a base polyol, 1 to 50 parts by weight per 100 parts polyols of a second polyol that is a ring-containing component load-bearing polyol, and a polyisocyanate, in the presence of a blowing agent, to form a foam intermediate composition, and fabricating a foam pad from the foam intermediate composition. The foam can have a 65% indentation force deflection guide factor of from 7 to 20 Newtons, optionally from 9 to 18 Newtons per 323 square cm. per kg/m³.

Even another aspect of the invention is a flexible foam pad made by reacting ingredients including a base polyol, 1 to 50 parts by weight per 100 parts polyols of a second polyol that is a ring-containing component load-bearing polyol, and a polyisocyanate, in the presence of a blowing agent, to form a foam intermediate composition, and fabricating a foam pad from the foam intermediate composition.

Even another aspect of the invention is a set of flexible polyurethane foam pads having different 65% indentation force deflection guide factor values, made from a single set of foam ingredients by providing a set of foam ingredients including a base polyol, a load-bearing polyol which is an aromatic polyester polyol, and a polyisocyanate, blending a first composition of the set of foam ingredients, with the base polyol and the load-bearing polyol present in a first proportion, to form a first foam intermediate composition, forming the first foam intermediate composition into a first foam pad having a first 65% indentation force deflection guide factor value, blending a second composition of the set of foam ingredients, the second composition having a different proportion of the load-bearing polyol from said first composition, to form a second foam intermediate composition, and forming the second foam intermediate composition into a second foam pad having a different 65% indentation force deflection guide factor value from the first foam pad. Optionally, the further step can be carried out of joining the first and second foams to form a one-piece pad having regions having different 65% indentation force deflections. Optionally, the first and second foam pads are used as separate parts having different 65% indentation force deflections.

Additionally, another aspect of the invention is a process of making a foam article including flexible foam including admixing a base polyol, a second polyol according to any aspect of the invention as defined here, a blowing agent, a polyisocyanate, a surfactant, and a catalyst.

Yet another aspect of the invention is a method of manufacturing a set of flexible polyurethane foams having different 65% indentation force deflection values from a single set of foam ingredients, including providing a set of foam ingredients including a base polyol, a load-bearing polyol which is an aromatic polyester polyol, and a polyisocyanate, blending a first composition of the set of foam ingredients with the base polyol and the load-bearing polyol present in a first proportion to form a first foam composition, forming the first foam composition into a first foam having a first 65% indentation force deflection value, blending a second composition of the set of foam ingredients, the second composition having a different proportion of the load-bearing polyol from said first composition, and forming the second composition into a second foam having a different 65% indentation force deflection value from the first foam. Optionally, the first and second foams either can be joined to form a one-piece pad having regions having different 65% indentation force deflections, or can be used to make separate parts having different 65% indentation force deflections.

### DETAILED DESCRIPTION OF THE INVENTION

The present invention is carried out by providing, making, or using a polyol or polyol blend foam intermediate composition or resultant foam product as described in the Summary of the Invention section above. The ingredients of such a polyol or polyol blend foam intermediate composition and how it is made and used are further described below.

In general, as set forth in the Background of the Invention section above, the polyol foam intermediate compositions of the present invention are components of a foam masterbatch (“B” side). As more fully described below, the masterbatch generally includes, but is not limited to, a base polyol, a ring-containing component polyol, a chemical or physical blowing agent, a surfactant, and a catalyst. Optionally, the masterbatch may also include other ingredients such as cross-linkers and copolymer polyols.

Masterbatch (“B” Side) Components Description

Base Polyol

High-resiliency molded polyurethane foams are typically prepared using polyether polyols having equivalent weights between about 1000 and 2500 g/equivalent and typically having 5 to 25% by weight end capping with ethylene oxide to provide primary hydroxyl contents ranging from about 65% to 90%. The functionality of these polyols is typically greater than about 2.0, and more preferably above about 2.4. Propylene oxide is preferred as the main comonomer in these types of polyether polyols.

Slabstock polyurethane flexible foams are typically prepared using polyether polyols having an equivalent weight between about 500 and 1600 g/equivalent. These polyols are generally terminated with mainly secondary hydroxyl groups, but may also be end capped with ethylene oxide to increase the primary hydroxyl group content. Ethylene oxide may also be randomly copolymerized with other alkylene oxides in these polyols, or block copolymerized to provide increased surfactancy and hydrophilicity. Propylene oxide is preferred as the main comonomer in these types of polyether polyols. The functionality of these polyols is typically greater than about 1.8, and more preferably greater than about 2.2.

An example of a commercially available base polyol for flexible molded foam is HYPERLITE E-848 from Bayer Corporation. HYPERLITE E-848 is an approximately 1800 equivalent weight (approximately 31.5 hydroxyl number) polyether polyol made by adding propylene oxide to an initiator compound to build an intermediate molecular weight and then capping with ethylene oxide to give a final product.

The equivalent weight values noted herein for the base polyol components which may be utilized indicate the mass of polyol per reactive hydroxyl group of the component polyols, and such values are typically expressed in units of g/equivalent.

The OH values noted herein for the base polyol components that may be utilized indicate the number of hydroxyl groups available for reaction in the described polyol, and such values are typically expressed in units of milligrams of KOH per gram of sample.

Ring-Containing Component Polyol

The contemplated polyol blend contains between 0.5 and 50% by weight of a ring-containing component polyol or ring-containing component polyol blend, preferably 1 to 45% by weight of the ring-containing component polyol or ring-containing component polyol blend, or most preferably from 5 to 40% by weight of the ring-containing component polyol or ring-containing component polyol blend.

The ring-containing component polyols may include, but are not limited to aromatic polyester polyols; heterocyclic polyols; spiro ring-containing component polyols; fused ring-containing component polyols; ring-containing component polyether polyols such as, for example, alkoxylated sucrose polyols; ring-containing component polyester polyols; alkoxylated ring-containing component aromatic and aliphatic diamines; alkoxylated phenol/formaldehyde resins; alkoxylated bis- or poly-phenols; alkoxylated dihydroxy benzenes and derivatives thereof; Mannich-type polyols; 1,4-cyclohexane dimethanol; dimethylol cyclopentadiene; alkoxylated piperazine; alkoxylated di- or poly-hydroxy naphthalenes; dihydroxy cyclohexane isomers; halogenated ring-containing component polyols; combinations thereof and derivatives thereof.

Many of the ring-containing component polyols are prepared as a result of alkoxylation of a ring-containing component initiator. This alkoxylation process occurs during the ring opening reaction or polymerization of an alkylene oxide or mixture of alkylene oxides or sequential addition of different alkylene oxides to a suitable ring-containing component initiator having active hydrogens in its structure. These reactions are usually carried out in the presence of either an acid or base catalyst. Alkylene oxides suitable for use in alkoxylating ring-containing component initiators include ethylene oxide, propylene oxide, butylene oxide, propylene carbonate, ethylene carbonate, styrene oxide, and epichlorohydrin. Alkoxylation frequently affords a number of benefits over using an active hydrogen-containing, ring-containing component initiator directly in the practice of this invention. For example, although polyphenols contain active hydrogens, the activity of the hydroxyl functionality of a phenol towards a polyisocyanate is relatively low, requiring relatively high levels of catalyst. Alkoxylation using ethylene oxide or propylene oxide, for example, converts the phenol hydroxyls into secondary or primary aliphatic hydroxyls, which are then readily reactive with polyisocyanates. Another example is that of ring-containing component polyamines. Ring-containing component aliphatic and aromatic amines, for example, often react at a rate that can be too fast compared to the other components of the polyol formulation, causing premature gelation and poor flow of the reacting foam mixture. Alkoxylation of these types of ring-containing component initiators can reduce their reactivity to allow them to be used at relatively higher levels without an overly detrimental influence on the flow characteristics or gel point. Further, the toxicity of certain ring-containing component aliphatic and aromatic amines may disallow their use in certain flexible foam applications. Alkoxylation of such ring-containing component amines usually reduces their toxicity to permit their use in foam applications.

Other ring-containing component polyols are identified, for example, in U.S. Pat. Nos. 6,359,022; 5,922,779; 4,722,803; 4,615,822; 4,608,432; 4,526,908; and 4,521,611; all issued to the present assignee and incorporated by reference for their description of ring-containing component polyols.

It is important that the average functionality of the ring-containing component polyol be high enough to avoid excessive chain termination during the polymerization process and hence allow growth in the overall molecular weight of the thermoset polymer. Thus, it is preferred that the average functionality of the ring-containing component polyol or ring-containing component polyol blend be greater than about 1.4, more preferred that the average functionality be greater than about 1.6 and most preferred that the average functionality be greater than about 1.7.

It is preferable that the average functionality of the ring-containing component polyol be low enough to avoid reductions in tensile strength, elongation and tear properties of the foams that are formed. Thus, it is preferred that the average functionality of the ring-containing component polyol or ring-containing component polyol blend be less than about 3.5, more preferably less than about 2.9 and most preferably below about 2.6. While many of the contemplated ring-containing component polyols possess a functionality outside of the range stated above, such polyols may be used in a ring-containing component polyol blend that would result in the polyol blend having an average functionality in the range stated above.

The ring-containing component aromatic and aliphatic amines which may be alkoxylated to form ring-containing component polyols and ring-containing component polyol blends include those having active hydrogens to allow them to be alkoxylated. Examples of the ring-containing component aliphatic amine alkoxylation initiators include, but should not be limited to the following amines, their substituted derivatives and isomers thereof; cyclohexyl amine; cyclopentyl amine; cyclohexane diamine; isophorone-diamine; piperazine; methylene bis(cyclohexylamine); methyl cyclohexane diamine; dimethyl cyclohexane diamine; and amino-1-alkyl piperidine and blends thereof. Additionally, the ring-containing component aliphatic amines may be heterocyclic in nature.

Examples of ring-containing component aromatic amine alkoxylation initiators include, but should not be limited to the following amines, their substituted derivatives and isomers thereof; methylene dianiline; aniline; toluene diamine; polymeric versions of methylene dianiline; diamino benzene; melamine; 4,4-methylene-bis-(2-chloroaniline); methylol melamines (such as those described in U.S. Pat. No. 4,458,034); N,N′-dialkyl methylene dianilines; N,N′-dialkyl phenylene diamines; diethyl toluene diamines; sulfonyl dianiline; isopropylidene dianiline; amino-benzylamines; chloro-anilines; phenylene diamine; benzyl amine; triphenyl methyl amine; and aminopyridine.

Examples of suitable heterocyclic ring-containing component polyols include, but should not be limited to: furan based polyols (such as those described in U.S. Pat. Nos. 4,316,935 and 4,426,460); alkoxylated melamines (such as those described in U.S. Pat. Nos. 4,656,201; 3,812,122; and 5,254,745); alkoxylated sucrose based polyols (such as those described in U.S. Pat. No. 3,153,002); alkoxylated lactose based polyols; alkoxylated fructose based polyols; alkoxylated methyl glucoside polyols (such as those described in U.S. Pat. No. 4,359,573); dihydroxy dioxane derivatives; trihydroxy dioxane derivatives; tetrahydroxy dioxane derivatives; polyhydroxy imidazolidone and alkoxylated polyhydroxy imidazolidones (such as those described in U.S. Pat. No. 5,238,971); and alkoxylated piperazines.

Mannich polyols are well known in the art and are prepared by alkoxylating a condensation product of a phenol or substituted phenol, formaldehyde and a dialkanol amine. The preparation of these polyols is described in U.S. Pat. Nos. 4,371,629; 3,297,597; 4,137,265; 4,383,102; 6,281,393; and 4,883,826; which are hereby incorporated by reference in their entireties. Additionally, although U.S. Pat. No. 4,371,629 B1 describes blends of Mannich polyols with flexible foam type polyols, this reference uses Mannich polyols in their pure state as crosslinking blend components, meaning that they have a functionality of about 4.0 or more which can cause losses in tensile, tear and elongation properties.

Alkoxylated phenol/formaldehyde resins are another example of suitable ring-containing component polyols. Polyols based on novolac resins or phenol/formaldehyde condensation resins are also well known in the art and are prepared by alkoxylating a condensation product of a phenol with formaldehyde. The preparation of these polyols is described in U.S. Pat. Nos. 3,497,465; 3,686,106 and 4,107,229.

Another example of a class of suitable ring-containing component polyols is the group consisting of the alkoxylated bisphenols. Alkoxylated bisphenols may be prepared by reacting the appropriate bisphenol with an alkylene oxide in the presence of an acidic or basic catalyst. Examples of bisphenols suitable for use as initiators in the practice of this invention include but should not be limited to: methylene bisphenol; sulfonyl diphenol; isopropylidene bisphenol; isopropylidene bis(dimethyl phenol); hexafluoroisopropylidene diphenol; isopropylidene bis(dibromo phenol); bis(4-hydroxyphenyl)-2,2-dichloroethylene; 4,4′-cyclohexylidene bisphenol; 4,4′-ethylidenebisphenol; 4,4′-(1,3-phenylenediisopropylidene)bisphenol; 4,4′-(1-phenylethylidene)bisphenol; 2,2′-dihydroxybiphenyl; 4,4′-dihydroxybiphenyl; di- or poly-hydroxyl naphthalenes; and mixtures thereof.

Another example of a class of suitable ring-containing component polyols includes the halogenated ring-containing component polyols. Examples of halogenated ring-containing component polyols suitable for the practice of this invention include but should not be limited to: glycol diesters of 3,4,5,6-tetrabromo-1,2-benzene dicarboxylic acid or anhydride (the diethylene glycol/propylene glycol mixed ester is sold as PHT-4 Diol by Great Lakes Chemical Corporation, and described in U.S. Pat. No. 4,069,207) and polyhydric alcohols derived from hexahalocyclopentadiene as described in U.S. Pat. No. 3,146,220 B1.

Ring-containing component polyester polyols are the product of esterification of a polyol and a polybasic acid, ester or anhydride or a polybasic acid, ester or anhydride mixture, wherein at least one of the two reactants contains a ring structure. The most common commercially available, ring-containing component polyester polyols are the aromatic polyester polyols, which are well known in the art (see for example, U.S. Pat. Nos. 4,608,432; 4,526,908; 4,529,744; 4,595,711; 4,521,611; 4,722,803; 4,644,027; 4,644,047; 4,644,048; 6,359,022; 5,922,779; 4,758,602; 4,701,477; 4,346,229; 4,604,410; 5360,900; 4,048,104; 4,485,196; 4,439,549; 4,615,822; 4,753,967 and WO 99/425,508. Each of these patents and the PCT application are incorporated by reference here in their entirety). These aromatic polyester polyols are prepared by forming esters between aromatic di- or poly-basic acids, esters or anhydrides and polyols or glycols.

Examples of aromatic di- and poly-basic acids, esters or anhydrides suitable for use in preparing aromatic polyester polyols include, but should not be limited to: phthalic anhydride; dimethyl terephthalate; terephthalic acid; isophthalic acid; 1,8-naphthalic anhydride; 1,8-naphthalic dicarboxylic acid; 1,8-dimethyl naphthalate; dimethyl isophthalate; phthalic acid; dimethyl terephthalate bottoms; phthalic anhydride bottoms; pyromellitic anhydride; mellitic anhydride; mellitic acid; trimellitic anhydride; 3,3′4,4′-benzophenone tetracarboxylic anhydride; 3,3′4,4′-benzophenone tetracarboxylic acid; trimellitic acid; polyethylene terephthalate recycled polymer; polybutylene terephthalate recycled polymer; polyethylene terephthalate virgin polymer; polybutylene terephthalate virgin polymer; mixtures thereof; and the like.

Examples of aliphatic ring-containing component dibasic acids suitable for use in preparing aliphatic ring-containing component polyester polyols include, but should not be limited to: 1,4-dicyclohexane dicarboxylic acid; tetrahydrophthalic acid; tetrahydrophthalic anhydride; 5-norbornene-2,3-dicarboxylic acid and its anhydride; 5-norbornane-2,3-dicarboxylic acid and its anhydride; and 1,4-dimethyl cyclohexane dicarboxylate.

If aliphatic, acyclic or linear di- and poly-basic acids, anyhydrides or esters are used in combination with the above described aromatic di- and poly-basic acids, esters or anhydrides, it is preferred that they be present at 20 mole % or less, based on the total amount of di- or poly-basic acid present.

Preferred examples of glycols suitable for use in preparing the ring-containing component polyester polyols include: glycerine; ethylene glycol; diethylene glycol; triethylene glycol; tetraethylene glycol; propylene glycol; dipropylene glycol; tripropylene glycol; tetrapropylene glycol; trimethylene glycol; 1,1,1-trimethylol ethane; 1,2,3-trimethylolpropane; pentaerythritol; and poly(oxyalkylene) polyols in which each repeating unit contains two to four carbon atoms derived from the condensation of ethylene oxide, propylene oxide, or butylene oxide and mixtures thereof; 2-methyl-1,3-dihydroxy propane; and mixtures thereof to form equivalent weights from about 116 to about 2000 g/equivalent. Optionally, aromatic polybasic acids, esters or anhydrides may be directly alkoxylated with ethylene oxide, propylene oxide, butylene oxide or mixtures thereof to provide suitable non-halogenated aromatic polyesters.

Suitable ring-containing component polyester polyols may be prepared from acyclic aliphatic di- or poly-basic acids or blends thereof and ring-containing component polyols. In this case, it is preferred to use aliphatic dicarboxylic acids (or their alkyl esters) having 2 to 12 carbons, more preferably 4 to 8 carbon atoms in the alkylene radical. Examples of these dicarboxylic acids (or their alkyl esters) include but should not be limited to: succinic; glutaric; pimelic; undecanoic; dodecanoic; dodecanedioic; subaric; azelaic; sebacic; and most preferably adipic and mixtures thereof. In this case, examples of suitable ring-containing component polyols include but should not be limited to: heterocycle-containing diols; spiro ring-containing component diols; fused ring-containing component diols; alkoxylated ring-containing component aromatic and aliphatic mono- and poly-amines; alkoxylated phenouformaldehyde resins; alkoxylated bis- or poly-phenols; alkoxylated dihydroxy benzenes and derivatives thereof; Mannich-type polyols; 1,4-cyclohexane dimethanol; dimethylol cyclopentadiene; alkoxylated piperazine; alkoxylated di- or poly-hydroxy naphthalenes; dihydroxy cyclohexane isomers; halogenated ring-containing component polyols; combinations thereof and derivatives thereof.

Primary, secondary and tertiary aliphatic hydroxyl functionalities are all suitable for the formation of the ring-containing component polyol blends. However, ring-containing component polyols which contain either substantially all primary hydroxyls or which contain mixtures of hydroxyls containing greater than about 35% by equivalent secondary hydroxyls with primary hydroxyls are preferred, mixtures of greater than about 50% by equivalent secondary hydroxyls with primary hydroxyls are more preferred and mixtures of greater than about 65% secondary hydroxyls are most preferred.

Light Transmission

One useful property of a polyol blend is translucence or transparency, which can be measured, for example, as the transmittance of 450 nanometer (nm) light. A transparent or at least translucent polyol blend is desirable, as it allows an operator to visually confirm that the polyol blend is being homogeneously mixed with other masterbatch components. (An opaque polyol blend blocks light transmission thus preventing visual confirmation of mixing). Another advantage of a non-opaque or transparent liquid polyol formulation is that any contaminants which might lodge in pipes, valves and filters are readily visible upon disassembly, allowing time saving during process troubleshooting.

Therefore, the present polyol blends are preferably non-opaque to 450 nm light, and optionally can have a 450 nm transmittance of at least 5%, at least 10%, at least 25%, at least 50%, at least 80%, at least 85%, at least 90%, or at least 95%.

The 450 nm wavelength optical transmission (in % transmission) of the polyol blend is determined using a Shimadzu 1601 UV-Visible spectrophotometer through a quartz cuvette having an internal pathlength of 1.00 cm. An empty quartz cuvette is used in the reference beam.

Although one objective of this invention is the replacement of copolymer polyol, it is anticipated that certain combinations of polyether polyol or polyether polyol blends; ring-containing component polyols or ring-containing component polyol blends; and copolymer polyol or copolymer polyol blends might provide certain performance benefits over combinations of polyether polyol or polyether polyol blends with ring-containing component polyols or ring-containing component polyol blends alone. It is reasonable, based on the viscosity results obtained in the practice of this invention, for example, to expect that certain polyether polyol/ring-containing component polyol/copolymer polyol combinations might allow for higher load-bearing at a given viscosity than a polyether polyol/ring-containing component polyol blend alone. In order to minimize the cost of such a ternary blend, it is preferred that the copolymer polyol have a dispersed solids content greater than about 30% by weight. It is most preferred that the copolymer polyol of such a ternary blend have a dispersed solids content of greater than about 35% by weight.

Ring-Containing Component Polyol Blend

Additionally contemplated is a ring-containing component polyol blend of any two or more of the ring-containing component polyols discussed above. For example, some of the blends of the present invention include, but are not limited to, ring-containing component polyol blends; non-halogenated ring-containing component polyol blends; non-halogenated aromatic polyester polyol blends, combinations thereof, and derivatives thereof. It is further contemplated that the non-halogenated ring-containing component polyol component of the present invention may be a mixture of the ring-containing component polyols.

Preferably, the mixtures of ring-containing component polyols have hydroxyl functionalities of between about 1.7 and 3.5. In one embodiment, ring-containing component polyol blends contain at least two secondary functional hydroxyl groups. In another embodiment, the ring-containing component polyol blends have primary hydroxyl groups. In a further embodiment, the ring-containing component polyol has both primary and secondary OH groups.

Like the ring-containing component polyols of the present invention, it is also preferable that the ring-containing component polyol blends and overall blends have reduced levels of suspended solids.

Blowing Agents

To prepare foam, water is most preferred for use as the blowing agent. However, any other way known to prepare polyisocyanate-based foams may be employed in addition to or instead of water. For example, the foam can be blown by using reduced or variable pressure, an inert gas such as nitrogen, air, carbon dioxide, argon, or other conventional blowing agents. Some examples of other conventional blowing agents are chorofluorocarbons, hydrofluorocarbons, hydrocarbons, hydrochlorocarbons, fluorocarbons, other classes of compounds having boiling points between about −20 and 100° C., and reactive blowing agents, i.e. agents which react with any of the ingredients, or decompose with heat in the reacting mixture, to liberate a gas which causes the mixture to foam.

Catalysts

The catalysts normally used to manufacture flexible foams are suitable for preparing the contemplated flexible foams. Included are organometallic compounds such as tin (II) salts of organic carboxylic acids and the dialkyl tin (IV) salts of organic carboxylic acids. These compounds may be used alone or preferably in combination with strongly basic amine compounds; tris (N,N-dialkyl aminoalkyl)-s-hexahydrotriazines; tetraalkyl ammonium hydroxides; alkali hydroxides; alkali alkoxides; alkali salts of long-chain fatty acids, optionally having side-positioned hydroxyl groups; alkali salts of N-(2-hydroxy-5-nonylphenol) methyl-methyl glycinate; and mixtures thereof. The preferred amine catalysts are tertiary amine compounds, while the preferred organometallic catalysts are based on tin. More preferred catalysts include, but are not limited to, 33 weight % solution of triethylene diamine in dipropylene glycol, available under the trademark DABCO 33-LV from Air Products and Chemicals, Incorporated, a 70 weight % solution of bis(dimethylaminoethyl) ether in dipropylene glycol, available under the trademark NIAX A-1 from Crompton-OSI Specialties, and an octoate salt such as potassium octoate. Other catalysts are identified in Table 4, where Examples 3, 6, 8, 10, 13, 15-17, 19, 25-27, 29-37, and 40-42 contain trimerization catalysts, listed as “additional catalysts/additives.” Trimerization catalysts are contemplated to aid the cure of the foam and to make the resulting foam harder.

Buffers

Another contemplated foam formulation ingredient is a buffer. Exemplary buffers contemplated herein include alkali carbonate salts, alkali bicarbonate salts, and mixtures thereof. Some specific buffers contemplated here include sodium carbonate, sodium bicarbonate, potassium carbonate, potassium bicarbonate, and mixtures thereof, either added as separate ingredients or formed in situ.

Surfactants

Typical surfactants which may be used include, but are not limited to, nonionic surfactants such as MAKON® surfactants sold by Stepan Company; silicone-based surfactants such as NIAX Y-10184 surfactant available from GE Silicones; and TEGOSTAB B 4690 available from Degussa-Goldschmidt Chemical.

Cross-Linkers

Examples of cross-linkers that may be used include, but are not limited to glycerin, trimethylol propane, diethanol amine, triethanol amine, and four or more functional polyols intended primarily for making rigid polyurethane foam.

Copolymer Polyols

An example of a copolymer polyol component suitable for use as an optional agent is HYPERLITE E-849, commercially available from Bayer Corporation. This particular copolymer polyol is a nominal 40 weight % styrene/acrylonitrile solids containing 18.4 OH number (3049 equivalent weight) polyol that is designed for use as a hardness adjusting agent in making molded polyurethane foams. Further examples of copolymer polyols that may be optionally incorporated into the present invention include, but are not limited to, those described within the Background of the Invention section set forth above.

Dendritic Macromolecules

An optional additive in the present compositions, contemplated for use as an auxiliary load-bearing improvement agent, is a dendritic macromolecule as discussed in PCT application WO 02/10247 A1, with reference to U.S. Provisional Application 60/221,512. A more extensive discussion of what is a dendritic macromolecule can be found in U.S. Pat. No. 6,093,777. All the patents and applications mentioned in this paragraph are hereby incorporated herein by reference to describe these dendritic macromolecules, how to make them, and how to use them in polyurethane foam compositions.

Inorganic Particulates

In some embodiments, inorganic particulates, such as fire retardant inorganic particulates, can be excluded from the polyol blends and formulations to reduce the potential for settling, separation and clogging of filters. In an alternative embodiment, however, low levels of inorganic particulates can be incorporated, preferably with relatively continuous agitation. Preferably, the level of inorganic particulates is less than about 10% by weight; more preferably less than about 5% by weight and most preferably below about 1% by weight.

Polyisocyanate (“A” Side) Component Description

Suitable organic polyisocyanates include any of those known in the art for the preparation of polyurethane foams, like aliphatic, cycloaliphatic, araliphatic and, preferably, aromatic polyisocyanates, such as toluene diisocyanate in the form of its 2,4 and 2,6-isomers and mixtures thereof and diphenylmethane diisocyanate in the form of its 2,4′-, 2,2′- and 4,4′-isomers and mixtures thereof.

An example of a suitable common polyisocyanate is an 80/20 isomer mixture of 2,4 and 2,6 toluene diisocyanate known as MONDUR TD-80, Grade A, which is commercially available from Bayer Corporation. Such toluene diisocyanates have a functionality of 2. Typically, the use of such toluene diisocyanates in preparing a flexible foam is associated with a TDI index. A TDI index is the value representing the amount of toluene diisocyanate (TDI) available for reaction with the polyol, water and other active-hydrogen sources in a foam producing formulation. An index of 105, for example, indicates that there is a 5% excess of toluene diisocyanate equivalents available over the stoichiometric (i.e., the exactly proportional) amount required by the formulation.

Suitable diphenylmethane diisocyanates (MDI's) include mixtures of diphenylmethane diisocyanates and oligomers thereof having a polyisocyanate functionality greater than 2, known in the art as “crude” or polymeric MDI (polymethylene polyphenylene polyisocyanates), the known variants of MDI comprising urethane, allophanate, urea, biuret, carbodiimide, uretonimine and/or isocyanurate groups. The variants may be obtained by introducing uretonimine and/or carbodiimide groups in the polyisocyanates, such as uretonimine and/or carbodiimide modified polyisocyanate having an NCO value of at least 20% by weight, and/or by reacting such a polyisocyanate with one or more polyols having a hydroxyl functionality of 2-6 and a molecular weight of 62-500 to obtain a modified polyisocyanate having an NCO value of at least 20% by weight.

Mixtures of toluene diisocyanate and diphenylmethane diisocyanate and/or prepolymers thereof (adjusting the functionality number below accordingly) and/or polymethylene polyphenylene polyisocyanates also may be used. For example, polyisocyanates can be used which have an average polyisocyanate functionality of 1.7 to 3.5 and preferably 1.8 to 3.2.

Foam Process Description—Molded

In general, a typical molded foam manufacturing facility for molding foams, in particular polyurethane foams, will consist of a metered foam mixing and dispensing unit, molds of a desired design, a mold conveying system, ovens, a roller crushing device, and related finished-foam handling systems. Such foam manufacture is typically automated where ever possible through the use of robotic devices.

The production of molded polyurethane foam typically involves the steps of mixing and dispensing a foam intermediate composition (i.e., combined “A” and “B” sides) as described herein and previously in the Background of the Invention section above) from a foam dispensing unit, as a foam intermediate composition, into a sufficiently heated mold of a desired design. The mold is typically vented to allow for the build-up and subsequent release of internal pressure, has two or more sections with provisions for automatic opening and closing, and may be formed from cast aluminum or any other suitable material.

Following the mixing and dispensing steps, the lid of the mold is closed and locked, and the foam intermediate composition is allowed to cure at a sufficient temperature, for a sufficient period of time. A sufficiently heated oven capable of receiving the mold may also be employed during the curing step.

Once the curing step is completed, the lid of the mold is opened and the resultant flexible foam product is removed. This process step is typically referred to in the flexible foam manufacturing industry as demolding. After demolding, the resultant foam product is typically delivered along a conveyor system to a foam cell-crushing device. The crusher device is used to apply pressure to the resultant flexible foam product to open the cells prior to being processed via other related finished-foam handling systems such as trimming and fabrication. During trimming and fabrication, the resultant flexible foam product is converted into a finished product such as an automobile seating cushion.

The viscosity determinations for the working examples are done in the conventional way using Brookfield rotational viscometers. For data at 25° C., samples in one quart, wide-mouth glass jars are measured using Brookfield's Model LVT viscometer.

The free-rise profile is an indication of how the foam will rise in the mold. This factor is important for two reasons. First, fill time is an important factor because the foam intermediate composition is poured into an open mold that typically is closed and locked before the rising foam fills the mold. If the closing lid touches the rising foam, gross foam instability problems will result. Second, fill time is also important for mold venting concerns. As the foam rises in the closed mold, the displaced air exits the mold through various vent holes. The timing of the closing for each vent device is critical so valuable foam material does not escape through the vent holes and become scrap.

Formulation of Masterbatches

The masterbatches were all prepared and then left overnight before foaming the next morning. The initial color of each masterbatch was white and opaque. The next morning, however, the ring-containing component polyol masterbatches had turned clear and ranged in color from water white to a light straw color.

Masterbatch Formulation Viscosity Test Results

The viscosity of the masterbatch is important because of the very practical concerns of foam makers that their equipment be able to accurately meter, mix and dispense the foam producing chemicals. The major benefits expected from the use of a lower viscosity masterbatch, utilizing the polyol blend of the present invention include, but are not limited to, easier pumping of the component polyol, the masterbatch and the foam intermediate composition during foam production; easier flow control and temperature control of the components, masterbatches, and foam intermediate compositions during foam production; improved ingredient mixing; and easier mold filling and wetting due to the reduced viscosity of the foam intermediate composition while being placed into that mold.

Material Handling

Another practical requirement of many molded foam producers is that no individual foam ingredient should exceed a viscosity of 10,000 mPa●s. The practical significance of this requirement relates to those producers' ability to off-load the product into their storage tanks and further handle the material within their respective production plants. Shipping the material at an elevated temperature is not usually an accepted option. The viscosity of the invention can be similar to that of conventional copolymer polyols such as HYPERLITE E-849. In its most preferred form, the invention does not exhibit a material-handling problem for producers.

Load-Bearing Testing and Test Results

The ability of a flexible polyurethane foam to receive and support weight is referred to as its load-bearing capacity. This property is typically quantified by measuring Indentation Force Deflection (IFD) as specified in ASTM D3574.

To be a good cushioning material, a foam desirably exhibits both comfort and support properties. Comfort results when a material is able to deflect its surface under low loads and conform to body shape. For foams, the comfort characteristics are typically judged up to about 25% deflection. Beyond 25% deflection, a foam desirably exhibits support characteristics adequate to hold the human body in the desired position. Thus, to avoid bottoming out, the design firmness of a cushioning product is typically set at 65% deflection.

The ring-containing component polyol type molecules contained within the polyol blends of the present invention demonstrate an ability to build load-bearing in an actual molded foam. Although not wanting to be bound by any particular theory, it is believed that by varying the use level and the choice of base polyol in the formulation, the ring-containing component polyol technology of the present invention could allow for the replacement of copolymer polyols in foam applications such as seat cushioning. To do so would overcome the shortcomings of the prior art foam formulations described in the Background of the Invention section above, while also providing cost savings.

Comparative Load-Bearing Efficiency Testing and Test Results

Foam manufacturers are interested in achieving a given load-bearing at a given or reduced foam density and at reduced raw material costs. Load-enhancing technologies are often compared in terms of how many additional Newtons of force are required to deflect the foam, per part of load-bearing additive in the foam formulation. Higher numbers indicate a higher efficiency for introducing load-bearing characteristics, which (at comparable raw material pricing) can translate into a less expensive foam pad. The load efficiency numbers are calculated for example by dividing the 65% IFD gain of the foam by the amount of load-bearing additive added. Such a calculation results in Newtons per part data. The total available range of Newtons is calculated as the practical use range times the efficiency number.

Masterbatch Color

The polyol blends made according to one aspect of the present invention can be essentially colorless, or optionally can have a Gardner color index not exceeding five, optionally not exceeding four, optionally not exceeding three, optionally not exceeding two, optionally not exceeding one.

### WORKING EXAMPLES

Foam Preparation

Bench scale cup foams were prepared as described in Herrington, R., Hinze, K., Porter, J., Skaggs, K., Burks, S., Thomas, R., Mispreuve, H. and Norton, M., “Chapter 5, Flexible Foam Preparation,” In Flexible Polyurethane Foams; Herrington, R. and K. Hock, eds., The Dow Chemical Company, Form No. 109-01061, (1997), 5.7-5.11, with the exceptions that the polyol side ingredients were mixed for a total of 30 seconds, and during the last 6 seconds of the mix the desired amount of toluene diisocyanate was rapidly added to the mixing cup. Time zero was taken as the beginning of the polyisocyanate addition. A more detailed description of the mixing procedure may be found in Farkas, P., Stanciu, R. and L. Mendoza, “Automotive, Molded Viscoelastic Foams”; Journal of Cellular Plastics 2002, 38/4, 341-354.

Hand-mixed foams were poured into a 15.125×15.125×4.0 inch (38.4×38.4×10.1 centimeter) electrically heated aluminum mold to prepare pads for physical property testing and to check for several processing characteristics. The base formulation below was used with MONDUR TD-80 Grade A at 105 index to prepare the flexible foams described here.

TABLE 2
Base Formulations

| Component | Parts |
|---|---|
| Base Polyol | 100-X |
| Load-bearing Agent | X |
| NIAX Y-10184 Surfactant | 1.20 |
| Diethanol Amine | 1.40 |
| DABCO 33-LV | 0.35 |
| NIAX A-1 | 0.08 |
| Water | 4.20 |

Note that when a copolymer polyol (CPP) containing 40% styrene/acrylonitrile (SAN) solids was used, X did not include the polyol portion (60% of the CPP), but only included the styrene/acrylonitrile (SAN) solids. In this instance, the base polyol included the polyol content of the CPP. For example, when 12 parts of SAN solids were being introduced, 30 parts of CPP were used, which provided 12 parts of SAN load-bearing agent solids and 18 parts of base polyol.

The foams were allowed to cure in the mold at the specified time and temperature (typically six minutes at 66° C.), removed from the mold, immediately placed on a flat table top and crushed by hand to open the cells.

The indentation force deflection values at 25% and 65% deflection (IFD), the hysteresis, and the guide factors were measured according to ASTM D3574.

The test results are summarized in Table 4. Comparative Examples A and B present results for molded flexible foams made using no load-bearing agent. Comparative Examples C through K contain prior art copolymer polyol to achieve their 65% IFD values at 32 kg/m³ density ranging from 35.7 to 40.7 lb per 50 sq.in. (318 to 361 N per 323 cm²).

Description of Materials and Abbreviations

In the working examples, summarized in Table 4, the following materials were used:

Agent 2637-70 is a 270 OH number (207 equivalent weight) diol type polyester polyol based on phthalic anhydride and dipropylene glycol, which has a nominal viscosity of 8000 mPa●s at 25° C.

Agent 0011-100 is a 214 equivalent weight aromatic polyester diol based on phthalic anhydride and diethylene glycol prepared by Stepan Company.

Agent 2371-51 is a 286 equivalent weight aromatic polyester diol based on iso-phthalic acid and diethylene glycol prepared by Stepan Company.

Agent 2815-04 is a 207 equivalent weight, aromatic polyester diol based on dimethyl terephthalate and dipropylene glycol prepared by Stepan Company.

Agent 2815-12 is a 126 equivalent weight, aromatic polyester diol based on phthalic anhydride and propylene glycol prepared by Stepan Company.

Bisphenol A+4 EO is a 202 equivalent weight diol formed by the reaction of bisphenol A with 2 moles of ethylene oxide (EO) per hydroxyl. This material was obtained from Aldrich Chemical Company.

Bisphenol A+2 PO is a 172 equivalent weight diol formed by the reaction of bisphenol A with one mole of propylene oxide per hydroxyl. This material was obtained from Aldrich Chemical Company.

CPP—an abbreviation for Copolymer Polyol. The solids content for each of the copolymer polyol containing foam runs was derived from HYPERLITE E-849 copolymer polyol, a nominal 40 weight % styrene/acrylonitrile solids containing, 3049 equivalent weight polyol supplied by Bayer Corporation.

CURITHANE 52 catalyst is a high-viscosity processing co-catalyst developed for use in rigid polyisocyanurate (PIR) foams, which has an equivalent weight of 112 and is available from Air Products Company.

1,4-Cyclohexanedimethanol was obtained from the Aldrich Chemical Company.

DABCO 33-LV—A commercial catalyst from Air Products Company consisting of 33 weight % triethylene diamine in dipropylene glycol.

DABCO K-15 is a trimerization catalyst consisting of potassium octoate dissolved in diethylene glycol to yield an equivalent weight of 207 and is available from Air Products Company.

DABCO T-12 is a dibutyl tin dilaurate based catalyst used for the production of polyurethane foams available from Air Products Company.

DEG-Diethylene glycol.

DEOA-Diethanolamine.

DPG-Dipropylene glycol.

HYPERLITE E-848 polyol is a nominal 1800 equivalent weight ethylene oxide capped polyether polyol available from Bayer Corporation.

MONDUR TD-80 Grade A is an 80/20 isomer mixture of 2,4 and 2,6 toluene diisocyanate supplied by Bayer Corporation.

NIAX A-1 is a catalyst supplied by Crompton-OSI Specialties consisting of 70 weight % bis(dimethylaminoethyl) ether in dipropylene glycol.

NIAX Y-10184 Surfactant is a silicone-based surfactant from GE Silicones.

POLYCAT 46 is a trimerization catalyst comprising potassium acetate in ethylene glycol and having an equivalent weight of 50.

SPECFLEX NC-630 is a nominal 1800 equivalent weight ethylene oxide capped polyol available from Dow Chemical Company.

STEPANPOL® is a registered trademark of Stepan Company for a line of phthalic anhydride-based polyols.

STEPANPOL® PD-110 LV is a 510 equivalent weight aromatic polyester polyol supplied by Stepan Company based on phthalic anhydride and diethylene glycol.

STEPANPOL® PS-2002 is a 195 OH number (288 equivalent weight) aromatic polyester polyol supplied by Stepan Company based on phthalic anhydride and diethylene glycol.

STEPANPOL® PS-2352 is a 240 OH number (234 equivalent weight) polyester polyol polyol supplied by Stepan Company based on phthalic anhydride and diethylene glycol.

STEPANPOL® PS-2402B is a 223 equivalent weight aromatic polyester polyol supplied by Stepan Company based on phthalic anhydride and diethylene glycol.

STEPANPOL® PS-20-200A is a 288 equivalent weight aromatic polyester polyol supplied by Stepan Company based on phthalic anhydride and diethylene glycol.

STEPANPOL® PS-4002 is a 140 equivalent weight aromatic polyester polyol supplied by Stepan Company based on phthalic anhydride and diethylene glycol.

TEGOSTAB B 4690 is a silicone surfactant from Degussa-Goldschmidt Chemical.

VORANOL 4053 polyol is a nominal 1800 equivalent weight cell opening type polyether polyol available from Dow Chemical Company.

Discussion of Test Results

Examples 1 through 44 as summarized in Table 4 show compositions that can provide excellent load-bearing in the absence of a copolymer polyol. Further, the foams of Examples 1 through 44 have a whiter color than the noticeably off-white copolymer polyol foams of Examples C through K.

The load-bearing efficiency is a measure of the effectiveness of the load-bearing agent at increasing the load-bearing as a function of the amount of the load-bearing agent used. The load-bearing efficiency is calculated by subtracting the 65% IFD of the load-bearing agent free foam of the same base polyol from that of the load-bearing agent-containing foam, and dividing the resulting difference by the weight percent of load-bearing agent in the polyol/load-bearing agent mixture. Since the base polyol contributes to the load-bearing, and since different base polyols have different load-bearing contributions, this method allows for a comparison of the load-bearing efficiency of the load-bearing agents alone.

The present formulations are capable of being fully homogeneous and typically have lower viscosity than the formulations of prior art technology. Table 4 provides examples of this. This can allow for more rapid material transfer between delivery and storage tanks and improved mixing with the relatively low viscosity polyisocyanates. Additionally, lower viscosities can provide improved temperature control, faster ingredient mixing, and easier mold filling and wetting.

The present polyol formulations can also be transparent, or at least non-opaque.

Since a foam prepared from the base polyol (without any load-bearing additive) has a load-bearing value, and since this value varies depending upon the type of base polyol used, it is important to measure this value for each base polyol for use in comparing the load-bearing efficiencies of the load-bearing additives. Comparative Examples A and B as summarized in Table 4 use SPECFLEX NC-630 and HYPERLITE E-848, respectively, as the base polyols and are free of load-bearing additives. The load-bearing values found in these foams were used to calculate the load-bearing efficiencies of Comparative Examples C through K and Working Examples 1 through 44. It is apparent that the compositions of the present invention can allow for greatly improved load-bearing efficiencies over those of the prior art.

Although the inventors are not willing to be bound to any particular theory, the ring-containing component polyols contained within the present polyol blends can function as load-bearing contributing additives in molded foams at normally desired deflections.

As noted in Table 4, the control foam of Examples C-K contains 12 weight percent of styrene/acrylonitrile solid particles, while the experimental foams contain 10-15 weight percent of the respective liquid ring-containing component polyol. Some of the ring-containing component polyols of the present invention demonstrated more than a 5% improvement in load-bearing versus the styrene/acrylonitrile reinforced foam.

Many of the examples of the invention in Table 4 demonstrate higher load-bearing efficiencies than those shown in Table 4 for the copolymer polyol formulations C-K. In addition, compositions are contemplated that employ less or none of a dispersion of solids (a copolymer polyol) as the load-bearing contribution additives. Reducing or eliminating the solids is expected to reduce the variability of solids loading in the formulation, thus reducing the variability in load-bearing performance of the resulting foam.

While particular elements, embodiments and applications of the present invention have been shown and described, it will be understood that the invention is not limited thereto since modifications may be made by those skilled in the art, particularly in light of the foregoing teachings. Therefore, it is understood that the embodiments described above are merely for illustrative purposes and are not intended to limit the spirit and scope of the invention, which is defined by the following claims as interpreted according to the principles of patent law, including the doctrine of equivalents.

TABLE 3
Typical Masterbatches

| | | STEPANPOL ® | STEPANPOL ® | Agent |
|---|---|---|---|---|
| Formulation | Control | PS-2002 | PS-2352 | 2637-70 |
| HYPERLITE E- | 70 | 88 | 88 | 88 |
| 848 | | | | |
| HYPERLITE E- | 30 | — | — | — |
| 849 | | | | |
| STEPANPOL PS- | — | 12 | — | — |
| 2002 | | | | |
| STEPANPOL PS- | — | — | 12 | — |
| 2352 | | | | |
| Agent 2637-70 | — | — | — | 12 |
| NIAX Y-10184 | 1.2 | 1.2 | 1.2 | 1.2 |
| Diethanol Amine | 1.4 | 1.4 | 1.4 | 1.4 |
| DABCO 33-LV | 0.35 | 0.35 | 0.35 | 0.35 |
| NIAX A-1 | 0.08 | 0.08 | 0.08 | 0.08 |
| Water | 4.2 | 4.2 | 4.2 | 4.2 |
| Initial Color | White, Opaque | White, Opaque | White, Opaque | White, Opaque |
| Final Color | White, Opaque | Clear, Water | Clear, Straw | Clear, Light |
| | | White | | Straw |
| Viscosity at 25° C., | 2385 | 2080 | 1830 | 1470 |
| mPa · s | | | | |

TABLE 4
Working Examples

| | Example # | | | |
|---|---|---|---|---|
| | A | B | C | D |
| Loadbearing Agent Proportion In | 0 | 0 | 12 | 12 |
| Polyol Blend (wt %) | | | | |
| Loadbearing Agent Type | NONE | NONE | CPP | CPP |
| Base Polyol Type | SPECFLEX | HYPERLITE | HYPERLITE | HYPERLITE |
| | NC-630 | E-848 | E-848 | E-848 |
| Additional Catalysts/Additives | NONE | NONE | NONE | NONE |
| Masterbatch Appearance | Clear | Clear | Opaque | Opaque |
| Mold Temp. (deg. C.) | 66 | 66 | 63 | 71 |
| Cure Time (min.) | 6 | 6 | 6 | 6 |
| Density (kg/m³) | 33 | 34.9 | 33.3 | 32.8 |
| 25% IFD (N/323 cm²) | 71 | 94 | 129 | 122 |
| 65% IFD (N/323 cm²) | 212 | 254 | 354 | 334 |
| Hysteresis Return (%) | 85 | 83 | 78 | 79 |
| 65% IFD Guide Factor ((N/323 cm²)/ | 6.42 | 7.28 | 10.63 | 10.18 |
| kg/m³) | | | | |
| 65% IFD (N/323 cm²) at 32 kg/m³ | 206 | 233 | 340 | 326 |
| via Guide Factor | | | | |
| 65% IFD Loadbearing Efficiency | na | na | 8.9 | 7.7 |
| (N per part of Loadbearing | | | | |
| Agent) | | | | |
| | Example # | | | |
| | E | F | G | H |
| Loadbearing Agent Proportion | 12 | 12 | 12 | 12 |
| In Polyol Blend (wt %) | | | | |
| Loadbearing Agent Type | CPP | CPP | CPP | CPP |
| Base Polyol Type | HYPERLITE | HYPERLITE | HYPERLITE | HYPERLITE |
| | E-848 | E-848 | E-848 | E-848 |
| Additional Catalysts/Additives | NONE | NONE | NONE | NONE |
| Masterbatch Appearance | Opaque | Opaque | Opaque | Opaque |
| Mold Temp. (deg. C.) | 77 | 60 | 57 | 54 |
| Cure Time (min.) | 6 | 6 | 6 | 6 |
| Density (kg/m³) | 32.5 | 33.3 | 32.2 | 33.3 |
| 25% IFD (N/323 cm²) | 117 | 133 | 122 | 133 |
| 65% IFD (N/323 cm²) | 323 | 363 | 346 | 371 |
| Hysteresis Return (%) | 81 | 78 | 76 | 78 |
| 65% IFD Guide Factor ((N/323 cm²)/ | 9.94 | 10.90 | 10.75 | 11.14 |
| kg/m³) | | | | |
| 65% IFD (N/323 cm²) at 32 kg/m³ | 318 | 349 | 344 | 357 |
| via Guide Factor | | | | |
| 65% IFD Loadbearing | 7.1 | 9.7 | 9.2 | 10.3 |
| Efficiency (N per part of | | | | |
| Loadbearing Agent) | | | | |

| | Example # | | |
|---|---|---|---|
| | I | J | K |
| Loadbearing Agent Proportion In | 12 | 12 | 12 |
| Polyol Blend (wt %) | | | |
| Loadbearing Agent Type | CPP | CPP | CPP |
| Base Polyol Type | HYPERLITE | HYPERLITE | SPECFLEX |
| | E-848 | E-848 | NC-630 |
| Additional Catalysts/Additives | NONE | NONE | NONE |
| Masterbatch Appearance | Opaque | Opaque | Opaque |
| Mold Temp. (deg. C.) | 59 | 66 | 66 |
| Cure Time (min.) | 6 | 6 | 6 |
| Density (kg/m³) | 33.3 | 32.4 | 33.3 |
| 25% IFD (N/323 cm²) | 134 | 125 | 129 |
| 65% IFD (N/323 cm²) | 367 | 338 | 376 |
| Hysteresis Return (%) | 77 | 79 | 81 |
| 65% IFD Guide Factor ((N/323 cm²)/ | 11.02 | 10.43 | 11.29 |
| kg/m³) | | | |
| 65% IFD (N/323 cm²) at 32 kg/m³ via | 353 | 334 | 361 |
| Guide Factor | | | |
| 65% IFD Loadbearing Efficiency (N | 10.0 | 8.4 | 13.0 |
| per part of Loadbearing Agent) | | | |

| | Example # | | | | |
|---|---|---|---|---|---|
| | 1 | 2 | 3 | 4 | 5 |
| Loadbearing Agent | 12 | 12 | 12 | 12 | 12 |
| Proportion In Polyol | | | | | |
| Blend (wt %) | | | | | |
| Loadbearing Agent | Bisphenol | 1,4 Cyclo- | Agent | Agent | Agent |
| Type | A + 2PO | hexanedi- | 2637-70 | 2637-70 | 2637-70 |
| | | methanol | | | |
| Base Polyol Type | SPECFLEX | SPECFLEX | SPECFLEX | SPECFLEX | SPECFLEX |
| | NC-630 | NC-630 | NC-630 | NC-630 | NC-630 |
| Additional Catalysts/ | NONE | NONE | 0.013 pph | NONE | 0.05 pph |
| Additives | | | Na₂CO₃/ | | DABCO |
| | | | 0.009 pph | | 33-LV |
| | | | NaHCO₃ | | |
| Masterbatch | Clear | Clear | Clear | Clear | Clear |
| Appearance | | | | | |
| Mold Temp. (deg. C.) | 66 | 66 | 66 | 54 | 66 |
| Cure Time (min.) | 6 | 6 | 6 | 6 | 6 |
| Density (kg/m³) | 32.5 | 33.2 | 32.8 | 34.6 | 32.7 |
| 25% IFD (N/323 cm²) | 161 | 130 | 145 | 125 | 123 |
| 65% IFD (N/323 cm²) | 487 | 454 | 419 | 414 | 380 |
| Hysteresis Return (%) | 67 | 73 | 70 | 72 | 75 |
| 65% IFD Guide Factor | 14.98 | 13.67 | 12.77 | 11.97 | 11.62 |
| ((N/323 cm²)/kg/m³) | | | | | |
| 65% IFD (N/323 cm²) | 480 | 438 | 409 | 383 | 372 |
| at 32 kg/m³ via | | | | | |
| Guide Factor | | | | | |
| 65% IFD Loadbearing | 22.8 | 19.3 | 16.9 | 14.8 | 13.9 |
| Efficiency (N per part | | | | | |
| of Loadbearing Agent) | | | | | |
| | Example # | | | | |
| | 6 | 7 | 8 | 9 | 10 |
| Loadbearing Agent | 12 | 12 | 12 | 12 | 12 |
| Proportion In Polyol | | | | | |
| Blend (wt %) | | | | | |
| Loadbearing Agent | Agent | Agent | Agent | Agent | Agent |
| Type | 2637-70 | 2637-70 | 2637-70 | 2637-70 | 2637-70 |
| Base Polyol Type | SPECFLEX | SPECFLEX | SPECFLEX | SPECFLEX | SPECFLEX |
| | NC-630 | NC-630 | NC-630 | NC-630 | NC-630 |
| Additional Catalysts/ | 0.10 pph | NONE | 0.03 pph | NONE | 0.10 pph |
| Additives | POLYCAT | | 45% KOH | | POLYCAT |
| | 46 | | in water | | 46 |
| Masterbatch | Clear | Clear | Clear | Clear | Clear |
| Appearance | | | | | |
| Mold Temp. (deg. C.) | 54 | 60 | 66 | 66 | 66 |
| Cure Time (min.) | 6 | 6 | 6 | 6 | 6 |
| Density (kg/m³) | 34.6 | 33.8 | 32.2 | 33.3 | 32.7 |
| 25% IFD (N/323 cm²) | 135 | 136 | 127 | 122 | 123 |
| 65% IFD (N/323 cm²) | 401 | 390 | 362 | 359 | 350 |
| Hysteresis Return (%) | 71 | 74 | 72 | 76 | 70 |
| 65% IFD Guide Factor | 11.59 | 11.54 | 11.24 | 10.78 | 10.70 |
| ((N/323 cm²)/kg/m³) | | | | | |
| 65% IFD (N/323 cm²) | 371 | 369 | 360 | 345 | 343 |
| at 32 kg/m³ via | | | | | |
| Guide Factor | | | | | |
| 65% IFD Loadbearing | 13.8 | 13.6 | 12.8 | 11.6 | 11.4 |
| Efficiency (N per part | | | | | |
| of Loadbearing Agent) | | | | | |
| | Example # | | | | |
| | 11 | 12 | 13 | 14 | 15 |
| Loadbearing Agent | 12 | 12 | 12 | 12 | 10 |
| Proportion In Polyol | | | | | |
| Blend (wt %) | | | | | |
| Loadbearing Agent | Agent | Agent | Agent 2637- | Agent | Agent |
| Type | 2815-04 | 2371-51 | 70 | 2637-70 | 2637-70 |
| Base Polyol Type | SPECFLEX | SPECFLEX | SPECFLEX | SPECFLEX | SPECFLEX |
| | NC-630 | NC-630 | NC-630 | NC-630 | NC-630 |
| Additional Catalysts/ | NONE | 1.0 pph | 0.10 pph | 0.05 pph | 0.10 pph |
| Additives | | NIAX Y- | CURITHANE | DABCO | POLYCAT |
| | | 10184 | 52 | 33LV | 46 |
| Masterbatch | Clear | Hazy | Clear | Clear | Clear |
| Appearance | | | | | |
| Mold Temp. (deg. C.) | 66 | 66 | 66 | 66 | 66 |
| Cure Time (min.) | 6 | 6 | 6 | 6 | 6 |
| Density (kg/m³) | 33.6 | 32.5 | 32.5 | 32.5 | 32.4 |
| 25% IFD (N/323 cm²) | 117 | 112 | 116 | 113 | 120 |
| 65% IFD (N/323 cm²) | 357 | 344 | 340 | 339 | 336 |
| Hysteresis Return (%) | 75 | 78 | 74 | 76 | 73 |
| 65% IFD Guide Factor | 10.63 | 10.58 | 10.46 | 10.43 | 10.37 |
| ((N/323 cm²)/kg/m³) | | | | | |
| 65% IFD (N/323 cm²) | 340 | 339 | 335 | 334 | 332 |
| at 32 kg/m³ via Guide | | | | | |
| Factor | | | | | |
| 65% IFD Loadbearing | 11.2 | 11.1 | 10.8 | 10.7 | 12.6 |
| Efficiency (N per part | | | | | |
| of Loadbearing Agent) | | | | | |
| | Example # | | | | |
| | 16 | 17 | 18 | 19 | 20 |
| Loadbearing Agent | 12 | 12 | 12 | 12 | 12 |
| Proportion In Polyol | | | | | |
| Blend (wt %) | | | | | |
| Loadbearing Agent | Agent 2637- | Agent | Agent | Agent 2637- | Agent |
| Type | 70 | 2637-70 | 2637-70 | 70 | 2637-70 |
| Base Polyol Type | SPECFLEX | SPECFLEX | SPECFLEX | SPECFLEX | SPECFLEX |
| | NC-630 | NC-630 | NC-630 | NC-630 | NC-630 |
| Additional Catalysts/ | 0.25 pph | 0.15 pph | NONE | 0.15 pph | NONE |
| Additives | CURITHANE | DABCO K- | | CURITHANE | |
| | 52 | 15 | | 52 + 0.50 pph | |
| | | | | VORANOL | |
| | | | | 4053 | |
| Masterbatch | Clear | Clear | Clear | Clear | Clear |
| Appearance | | | | | |
| Mold Temp. (deg. C.) | 66 | 66 | 71 | 66 | 66 |
| Cure Time (min.) | 6 | 6 | 6 | 6 | 6 |
| Density (kg/m³) | 32.8 | 32.4 | 33.2 | 32.8 | 33.2 |
| 25% IFD (N/323 cm²) | 117 | 114 | 117 | 111 | 107 |
| 65% IFD (N/323 cm²) | 339 | 333 | 338 | 330 | 330 |
| Hysteresis Return | 71 | 72 | 78 | 76 | 76 |
| (%) | | | | | |
| 65% IFD Guide | 10.34 | 10.28 | 10.18 | 10.06 | 9.94 |
| Factor ((N/323 cm²)/ | | | | | |
| kg/m³) | | | | | |
| 65% IFD (N/323 cm²) | 331 | 329 | 326 | 322 | 318 |
| at 32 kg/m³ via Guide | | | | | |
| Factor | | | | | |
| 65% IFD | 10.4 | 10.3 | 10.0 | 9.7 | 9.4 |
| Loadbearing | | | | | |
| Efficiency (N per part | | | | | |
| of Loadbearing | | | | | |
| Agent) | | | | | |
| | Example # | | | | |
| | 21 | 22 | 23 | 24 | 25 |
| Loadbearing Agent | 12 | 12 | 10 | 12 | 12 |
| Proportion In Polyol | | | | | |
| Blend (wt %) | | | | | |
| Loadbearing Agent | Stepanol | STEPANPOL | Agent | Agent | STEPANPOL |
| Type | PS-2002 | PD-110LV | 2637-70 | 0011-100 | PS-2002 |
| Base Polyol Type | SPECFLEX | SPECFLEX | SPECFLEX | SPECFLEX | SPECFLEX |
| | NC-630 | NC-630 | NC-630 | NC-630 | NC-630 |
| Additional Catalysts/ | .05 pph | NONE | NONE | NONE | .05 pph |
| Additives | DABCO T- | | | | K₂CO₃ |
| | 12 | | | | |
| Masterbatch | Clear | Hazy | Clear | Clear | Hazy |
| Appearance | | | | | |
| Mold Temp. (deg. C.) | 66 | 66 | 66 | 66 | 66 |
| Cure Time (min.) | 6 | 6 | 6 | 6 | 6 |
| Density (kg/m³) | 32.2 | 31.9 | 32.8 | 33 | 33.2 |
| 25% IFD (N/323 cm²) | 113 | 108 | 97 | 89 | 92 |
| 65% IFD (N/323 cm²) | 318 | 307 | 301 | 266 | 266 |
| Hysteresis Return (%) | 78 | 78 | 80 | 82 | 83 |
| 65% IFD Guide | 9.88 | 9.62 | 9.18 | 8.06 | 8.01 |
| Factor ((N/323 cm²)/ | | | | | |
| kg/m³) | | | | | |
| 65% IFD (N/323 cm²) | 316 | 308 | 294 | 258 | 256 |
| at 32 kg/m³ via Guide | | | | | |
| Factor | | | | | |
| 65% IFD | 9.2 | 8.5 | 8.8 | 4.4 | 4.2 |
| Loadbearing | | | | | |
| Efficiency (N per part | | | | | |
| of Loadbearing | | | | | |
| Agent) | | | | | |
| | Example # | | | | |
| | 26 | 27 | 28 | 29 | 30 |
| Loadbearing | 12 | 12 | 12 | 12 | 12 |
| Agent | | | | | |
| Proportion In | | | | | |
| Polyol Blend (wt %) | | | | | |
| Loadbearing | STEPANPOL | STEPANPOL | STEPANPOL | STEPANPOL | STEPANPOL |
| Agent Type | PS-2002 | PS-2002 | PS-4002 | PS-2002 | PS-2002 |
| Base Polyol Type | SPECFLEX | SPECFLEX | SPECFLEX | SPECFLEX | SPECFLEX |
| | NC-630 | NC-630 | NC-630 | NC-630 | NC-630 |
| Additional | 0.013 pph | 0.022 pph | NONE | 0.021 pph | 0.018 pph |
| Catalysts/ | Na₂CO₃/ | Na₂CO₃ | | KHCO₃ | NaHCO₃ |
| Additives | 0.009 | | | | |
| | NaHCO₃ | | | | |
| Masterbatch | Hazy | Hazy | Clear | Hazy | Hazy |
| Appearance | | | | | |
| Mold Temp. | 66 | 66 | 66 | 66 | 66 |
| (deg. C.) | | | | | |
| Cure Time | 6 | 6 | 6 | 6 | 6 |
| (min.) | | | | | |
| Density (kg/m³) | 34 | 32.4 | 34 | 33.2 | 33.5 |
| 25% IFD (N/323 cm²) | 92 | 86 | 81 | 85 | 84 |
| 65% IFD (N/323 cm²) | 271 | 254 | 266 | 256 | 253 |
| Hysteresis | 82 | 81 | 83 | 85 | 83 |
| Return (%) | | | | | |
| 65% IFD Guide | 7.97 | 7.84 | 7.82 | 7.71 | 7.55 |
| Factor ((N/323 cm²)/ | | | | | |
| kg/m³) | | | | | |
| 65% IFD (N/323 cm²) | 255 | 251 | 250 | 247 | 242 |
| at 32 kg/m³ | | | | | |
| via Guide Factor | | | | | |
| 65% IFD | 4.1 | 3.8 | 3.7 | 3.4 | 3.0 |
| Loadbearing | | | | | |
| Efficiency (N per | | | | | |
| part of | | | | | |
| Loadbearing | | | | | |
| Agent) | | | | | |
| | Example # | | | | |
| | 31 | 32 | 33 | 34 | 35 |
| Loadbearing | 12 | 15 | 15 | 12 | 12 |
| Agent | | | | | |
| Proportion In | | | | | |
| Polyol Blend (wt | | | | | |
| %) | | | | | |
| Loadbearing | STEPANPOL | Agent 2637- | Agent 2637- | Agent 2637- | Agent 2637- |
| Agent Type | PS-2002 | 70 | 70 | 70 | 70 |
| Base Polyol Type | SPECFLEX | HYPERLITE | HYPERLITE | HYPERLITE | HYPERLITE |
| | NC-630 | E-848 | E-848 | E-848 | E-848 |
| Additional | 0.017 pph | 0.073 pph | 0.013 pph | 0.10 pph | 0.10 pph |
| Catalysts/ | K₂CO₃/ | 45% KOH in | Na₂CO₃/ | POLYCAT | POLYCAT 46 |
| Additives | 0.011 pph | Water | 0.009 pph | 46 | |
| | KHCO₃ | | NaHCO₃ | | |
| Masterbatch | Hazy | Clear | Clear | Clear | Clear |
| Appearance | | | | | |
| Mold Temp. | 66 | 66 | 66 | 66 | 66 |
| (deg. C.) | | | | | |
| Cure Time | 6 | 6 | 6 | 6 | 4.5 |
| (min.) | | | | | |
| Density (kg/m³) | 33.2 | 32.5 | 32.2 | 32.8 | 32.8 |
| 25% IFD (N/323 cm²) | 89 | 139 | 134 | 133 | 117 |
| 65% IFD (N/323 cm²) | 248 | 416 | 402 | 391 | 359 |
| Hysteresis | 82 | 65 | 63 | 68 | 67 |
| Return (%) | | | | | |
| 65% IFD Guide | 7.47 | 12.80 | 12.48 | 11.92 | 10.95 |
| Factor ((N/323 cm²)/ | | | | | |
| kg/m³) | | | | | |
| 65% IFD (N/323 cm²) | 239 | 410 | 400 | 381 | 350 |
| at 32 kg/m³ | | | | | |
| via Guide Factor | | | | | |
| 65% IFD | 2.8 | 11.8 | 11.1 | 12.4 | 9.8 |
| Loadbearing | | | | | |
| Efficiency (N per | | | | | |
| part of | | | | | |
| Loadbearing | | | | | |
| Agent) | | | | | |
| | Example # | | | | |
| | 36 | 37 | 38 | 39 | 40 |
| Loadbearing Agent | 12 | 12 | 10 | 12 | 15 |
| Proportion In | | | | | |
| Polyol Blend (wt | | | | | |
| %) | | | | | |
| Loadbearing Agent | Agent 2637- | Agent 2637- | STEPANPOL | Bisphenol | STEPANPOL |
| Type | 70 | 70 | PS-2402B | A + 4 EO | PS-2402B |
| Base Polyol Type | HYPERLITE | HYPERLITE | HYPERLITE | SPECFLEX | HYPERLITE |
| | E-848 | E-848 | E-848 | NC-630 | E-848 |
| Additional | 0.073 pph | 0.013 pph | NONE | NONE | 0.07 pph 45% |
| Catalysts/Additives | 45% KOH in | Na₂CO₃/ | | | KOH in |
| | Water | 0.009 pph | | | Water |
| | | NaHCO₃ | | | |
| Masterbatch | Clear | Clear | Clear | Clear | Clear |
| Appearance | | | | | |
| Mold Temp. | 66 | 66 | 66 | 66 | 66 |
| (deg. C.) | | | | | |
| Cure Time (min.) | 6 | 6 | 6 | 6 | 6 |
| Density (kg/m³) | 32 | 30.8 | 30.4 | 33.6 | 33.6 |
| 25% IFD (N/323 cm²) | 115 | 86 | 100 | 125 | 102 |
| 65% IFD (N/323 cm²) | 343 | 275 | 265 | 393 | 313 |
| Hysteresis Return | 69 | 64 | 77 | 73 | 76 |
| (%) | | | | | |
| 65% IFD Guide | 10.72 | 8.93 | 8.72 | 11.70 | 9.32 |
| Factor ((N/323 cm²)/ | | | | | |
| kg/m³) | | | | | |
| 65% IFD (N/323 cm²) | 343 | 286 | 279 | 374 | 298 |
| at 32 kg/m³ via | | | | | |
| Guide Factor | | | | | |
| 65% IFD | 9.2 | 4.4 | 4.6 | 14.1 | 4.3 |
| Loadbearing | | | | | |
| Efficiency (N per | | | | | |
| part of | | | | | |
| Loadbearing | | | | | |
| Agent) | | | | | |

Example #

| | 41 | 42 | 43 | 44 |
|---|---|---|---|---|
| Loadbearing Agent | 12 | 12 | 12 | 12 |
| Proportion In Polyol | | | | |
| Blend (wt %) | | | | |
| Loadbearing Agent | STEPANPOL | Agent 2637- | Agent 2637- | Agent |
| Type | PS-2402B | 70 | 70 | 2815-12 |
| Base Polyol Type | HYPERLITE | HYPERLITE | HYPERLITE | SPECFLEX |
| | E-848 | E-848 | E-848 | NC-630 |
| Additional Catalysts/ | 0.07 pph 45% | 0.07 pph | NONE | NONE |
| Additives | KOH in | 45% KOH in | | |
| | Water | Water | | |
| Masterbatch | Clear | Clear | Clear | Clear |
| Appearance | | | | |
| Mold Temp. (deg. C.) | 66 | 66 | 66 | 66 |
| Cure Time (min.) | 6 | 6 | 6 | 6 |
| Density (kg/m³) | 33 | 33 | 30 | 33 |
| 25% IFD (N/323 cm²) | 98 | 98 | 87 | 150 |
| 65% IFD (N/323 cm²) | 286 | 286 | 260 | 436 |
| Hysteresis Return (%) | 79 | 79 | 71 | 74 |
| 65% IFD Guide Factor | 8.67 | 8.67 | 8.67 | 13.21 |
| ((N/323 cm²)/kg/m³) | | | | |
| 65% IFD (N/323 cm²) | 277 | 277 | 277 | 423 |
| at 32 kg/m³ via Guide | | | | |
| Factor | | | | |
| 65% IFD Loadbearing | 3.7 | 3.7 | 3.7 | 18.1 |
| Efficiency (N per part | | | | |
| of Loadbearing Agent) | | | | |

What is claimed is:

1. A polyol blend comprising:
(a) 61 to 99 parts by weight per 100 parts polyols of a base polyol or base polyol blend, wherein the base polyol or base polyol blend comprises a polyether polyol; and
(b) 1 to 39 parts by weight per 100 parts polyols of a ring-containing, load-bearing component polyol or a ring-containing, load-bearing component polyol blend which consists essentially of the reaction product of a phthalic acid, anhydride, diester, or a mixture thereof with a glycol or glycol mixture, and further having a hydroxyl functionality between 1.7 and 3.5 the polyol blend being substantially free of inorganic fire retardant particulates; the ring-containing component polyol or ring-containing component polyol blend having less than about 20 mole % linear aliphatic dibasic acid; the ring-containing component polyol further comprising a copolymer polyol having a solids content of greater than 30 weight percent; the polyol blend being substantially free of aromatic diamines; and
wherein the polyol blend is used to make a flexible foam having a 65% indentation force deflection guide factor of from 5 Newtons to 20 Newtons per 323 sq. cm. per kg/m³.

2. A polyol blend for making flexible foam comprising:
(a) 61 to 99 parts by weight per 100 parts polyols of a base polyol or base polyol blend, wherein the base polyol or base polyol blend comprises a polyether polyol; and
(b) 1 to 39 parts by weight per 100 parts polyols of a ring-containing, load-bearing component polyol or a ring-containing, load-bearing component polyol blend which consists essentially of the reaction product of a phthalic acid, anhydride, diester, or a mixture thereof with a glycol or glycol mixture, and further having a hydroxyl functionality between 1.7 and 3.5 the polyol blend being substantially free of inorganic fire retardant particulates; the ring-containing component polyol or ring-containing component polyol blend having less than about 20 mole % linear aliphatic dibasic acid; the polyol blend being substantially free of load-bearing-enhancing solids; the polyol blend being substantially free of aromatic diamines; and
wherein the polyol blend is used to make a flexible foam having a 65% indentation force deflection guide factor of from 5 Newtons to 20 Newtons per 323 sq. cm. per kg/m³.

3. A polyol blend suitable for use in preparing a flexible foam comprising:
(a) 61 to 99 parts by weight per 100 parts polyols of at least one base polyol, wherein the base polyol comprises a polyether polyol; and
(b) 1 to 39 parts by weight per 100 parts polyols of a load-bearing polyol consisting essentially of an aromatic/polyester polyol which consists essentially of the reaction product of a phthalic acid, anhydride, diester or a mixture thereof with a glycol or glycol mixture; said polyol blend being reacted with a polyisocyanate under foam forming conditions to produce a flexible foam having a 65% indentation force deflection guide factor of from 5 Newtons to 20 Newtons per 323 sq. cm. per kg/m³.

4. The polyol blend of claim 3, wherein said polyol blend has a Gardner color index not exceeding 5.

5. The polyol blend of claim 2, wherein the polyether polyol has an equivalent weight between about 1000 and 2500 g/equivalent.

6. The polyol blend of claim 3, wherein the polyether polyol has an equivalent weight between about 500 and 1600 g/equivalent.

7. The polyol blend of claim 3, wherein said polyol blend is substantially free of aromatic diamines, and wherein said load-bearing polyol has a hydroxyl functionality between 1.7 and 3.5 and has greater than 50% of its hydroxyl groups as secondary hydroxyl groups, and being substantially free of load-bearing enhancing solids.

8. The polyol blend of claim 7, wherein the base polyol comprises less than 10 weight percent ring-containing component dibasic acid, ring-containing component anhydride or ring-containing component diester.

9. The invention of claim 3, wherein the polyol blend comprises a buffer.

10. The invention of claim 7, wherein the polyol blend comprises a trimerization catalyst.

11. A polyol blend suitable for use in preparing a flexible foam comprising:
(a) 61 to 99 parts by weight per 100 parts polyols of at least one base polyol comprising polyether polyol; and
(b) 1 to 39 parts by weight per 100 parts polyols of a ring-containing component load-bearing polyol which consists essentially of the reaction product of a phthalic acid, anhydride diester or a mixture thereof with a glycol or glycol mixture; the viscosity of said polyol blend not exceeding about 10,000 mPa●s when measured at 25° C. using a Brookfield viscometer, said load bearing polyol providing a load-bearing efficiency at 65% indentation force deflection of from 2 to 25 Newtons per part by weight of said load-bearing polyol when said polyol blend is reacted with a polyisocyanate in the presence of a blowing agent to form a flexible foam.

12. The polyol blend of claim 11, wherein said load-bearing efficiency is from 13 to 25 Newtons per 323 sq. cm. per part by weight of said load-bearing polyol.

13. A polyol blend suitable for use in preparing a flexible foam comprising:
(a) 61 to 99 parts by weight per 100 parts polyols of a base polyol or base polyol blend, wherein the base polyol or base polyol blend comprises a polyether polyol; and
(b) 1 to 39 parts by weight per 100 parts polyols of a ring-containing, load-bearing component polyol or a ring-containing, load-bearing component polyol blend which consists essentially of the reaction product of a phthalic acid, anhydride, diester, or a mixture thereof with a glycol or glycol mixture, and further having a hydroxyl functionality between 1.7 and 3.5;
the polyol blend being substantially free of inorganic fire retardant particulates; the ring-containing component polyol or ring-containing component polyol blend having less than about 20 mole % linear aliphatic dibasic acid; the ring-containing component polyol further comprising from 0.5% to 30% by weight of a dendritic macromolecule.

14. The invention of claim 13, wherein the polyol blend comprises a trimerization catalyst.

15. A polyol blend suitable for use in preparing a flexible foam comprising:
(a) 61 to 99 parts by weight per 100 parts polyols of a base polyol or base polyol blend, wherein the base polyol or base polyol blend comprises a polyether polyol; and
(b) 1 to 39 parts by weight per 1000 parts polyols of a ring-containing component polyol or polyol blend having a hydroxyl functionality between 1.7 and 3.5, the ring-containing component polyol being selected from the group consisting of aromatic polyester polyols which consist essentially of the reaction product of an aromatic dibasic acid, aromatic anhydride, aromatic diester or mixture thereof with a glycol or glycol mixture, heterocyclic polyols, spiro ring-containing component polyols, fused ring-containing component polyols, non-aromatic ring-containing component polyester polyols, alkoxylated phenol/formaldehyde resins, alkoxylated bis-phenols, alkoxylated poly-phenols, alkoxylated dihydroxy benzenes, Mannich polyols, 1, 4-cyclohexane dimethanol, dimethylol cyclopentadiene, alkoxylated piperzine, alkoxylated di-hydroxy naphthalenes, alkoxylated poly-hydroxy naphthalenes, dihydroxy cyclohexane isomers, halogenated ring-containing component polyols, and derivatives and mixtures thereof, the polyol or polyol blend being substantially free of aromatic diamines.

16. The invention of claim 15, wherein the polyol blend comprises a trimerization catalyst.

17. The invention of claim 15, wherein the polyol blend comprises a buffer.

18. The invention of claim 15, wherein the polyol blend comprises a buffer.

19. The polyol blend of claim 13, wherein the polyol blend is used to make a flexible foam having a 65% indentation force deflection guide factor of from 5 Newtons to 20 Newtons per 323 sq. cm. per kg/m³.

20. The polyol blend of claim 13, wherein the polyol blend is substantially free of aromatic diamines.
